(19) United States
(12) Patent Application Publication
(10) Pub. No.: US 2010/0088245 A1
(43) Pub. Date: Apr. 8, 2010

(54) SYSTEMS AND METHODS FOR DEVELOPING STUDIES SUCH AS CLINICAL TRIALS

(76) Inventors: William Sean Harrison, Smyrna, TN (US); Paul J. Smith, Nashville, TN (US)

Correspondence Address: SCHWEGMAN, LUNDBERG & WOESSNER, P.A., P.O. BOX 2938, MINNEAPOLIS, MN, 55402, US

(21) Appl. No.: 12/574,338

(22) Filed: Oct. 6, 2009

Related U.S. Application Data
(60) Provisional application No. 61/195,387, filed on Oct. 7, 2008.

(51) Int. Cl. G06Q 50/00; G06F 17/30

(52) U.S. Cl. 705/317; 707/769; 707/E17.014

(57) ABSTRACT

Systems and methods are described for developing studies such as clinical trials, including computer-assisted recruitment or selection of patients, clinical trial investigators, facilities, or clinical trial study sites. In certain examples, computer-processing of physician records scores physicians potential investigators, as determined from at least one physician characteristic, and the physician's proximity to the nearest clinical trial study site. Clinical trial study sites are also scored. In certain examples, at least one physician characteristic is used to score potential clinical trial study sites. Processes for engaging physicians and their patients in clinical trial studies are also described. Suitable patients can be contacted through their physicians or other caregivers to participate in the clinical trial study.

### RELATED APPLICATIONS

This application claims priority back to U.S. Provisional Application Ser. No. 61/195,387, filed Oct. 7, 2008, which is hereby incorporated by reference in its entirety. This application is related to U.S. patent application Ser. No. 11/360,800, Ser. No. 11/460,920, Ser. No. 11/460,924 and Ser. No. 11/460,926 all filed on Jul. 28, 2006, which are hereby incorporated by reference and made a part hereof.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008, Provisio, Inc. (d/b/a iTrials), All Rights Reserved.

### TECHNICAL FIELD

This patent document pertains generally to computer systems and accompanying software for adapting the function of such computer systems, and more particularly, but not by way of limitation, to substantially automated systems and methods for developing studies such as clinical trials that involve recruiting suitable patients. Additionally, this patent document pertains to methods or processes for developing studies such as clinical trials that in some examples do not involve computer systems or software.

### BACKGROUND

With increasing industry pressure to develop, test and market greater numbers of new drugs faster, pharmaceutical companies (as well as biotechnology, medical device, etc. companies) need to perform clinical trials as quickly as possible. Clinical trials are conducted in phases, and each phase has a different purpose and helps scientists answer different questions. In Phase I trials, researchers test an experimental drug or treatment in a small group of people (e.g. 20-80) for the first time to evaluate its safety, determine a safe dosage range, and identify side effects. During Phase II trials, the experimental study drug or treatment is given to a larger group of people (e.g. 100-300) to see if it is effective and to further evaluate its safety. During Phase III trials, the experimental study drug or treatment is given to large groups of people (e.g. 1,000-3,000) to confirm its effectiveness, monitor side effects, compare it to commonly used treatments, and collect information that will allow the experimental drug or treatment to be used safely. During Phase IV trials, post marketing studies delineate additional information including the drug's risks, benefits, and optimal use. Each respective trial phase requires a unique set of patients, thus requiring vast clinical trial patient recruitment efforts. Inefficient clinical trial patient recruitment processes will increasingly become a formidable barrier to companies' success in launching new drugs or medical products. Improving the patient and physician recruitment process is imperative to avoid wasted investments and to eliminate costly delays in bringing new drugs and products to market—today and even more so in the future.

The difficulty that most companies face in recruiting and retaining clinical trial patients is a major cause of clinical trial delays. Over three-quarters of all clinical trials currently fail to meet their recruitment deadlines (with other data stating that 80% to 90% of clinical trials are not completed on time.) Improved patient and physician recruitment for clinical trials presents one of the largest opportunities for companies to eliminate delays in clinical trials, thereby making it possible to reduce time to market for new drugs or medical devices. In addition, because pharmaceutical and other companies are targeting more diverse populations and multiple therapeutic areas, clinical trials have become more complex and costly, and this trend is likely to escalate.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram of portions of a system for computer-assisted patient and physician recruitment for a clinical trial and portions of an environment in which it is used.

FIG. 2 is a flow chart illustrating an example of a method for identifying an investigator for a clinical trial.

FIG. 3 is a flow chart illustrating another example of a method for identifying an investigator that includes accessing a patient database.

FIG. 4 is a flow chart illustrating an example method for identifying at least one clinical trial site.

FIG. 5 is a flow chart illustrating another example clinical trial site selection process tailored towards clinical trials that place great emphasis on investigator capabilities.

FIG. 6 is a flow chart illustrating an example commercial implementation of a method for identifying a suitable clinical trial site.

FIG. 7A is a table illustrating example output on the evaluation of patient clusters.

FIG. 7B is a table illustrating different CPT codes utilized within an example physician selection process.

FIG. 7C is a table illustrating how physicians are filtered through procedure preference.

FIG. 8 is a table listing physicians by percentage use of a particular procedure.

FIG. 9 is a map illustrating the system's clustering capabilities.

FIG. 10 is a table listing potential clinical trial sites ranked according to physician (investigator) scoring.

FIG. 11A is a cluster map illustrating detailed output from the patient and physician recruitment system.

FIG. 11B is a chart depicting a selected cluster's score relative to all scored clusters.

FIG. 12A is a chart depicting a selected cluster's candidate count relative to all cluster's candidate counts.

FIG. 12B is a chart depicting a selected cluster's distance to nearest clinical trial site in comparison to all cluster's distance to nearest site.

FIG. 12C is a chart depicting a selected cluster's distance to nearest metropolitan area in comparison to all cluster's distance to nearest metropolitan area.

FIG. 12D is a table listing target investigator's specialties and patient count.

FIG. 13 illustrates system output summarizing cluster information.

FIG. 14 is a flow chart illustrating an example method for creating a group of targeted patients for clinical trial recruitment.

FIG. 15 is a flow chart illustrating an overview of an example process for physician and patient outreach communications.

FIG. 16 is a flow chart illustrating an example of initial physician communication.

FIG. 17 is a flow chart illustrating an example of follow-up physician communication.

FIG. 18 is a flow chart illustrating an example of inbound physician communication processing.

FIG. 19 is a flow chart illustrating an example of processing inbound patient communications.

FIG. 20 is a flow chart illustrating an example of handling patient referrals to clinical trial sites.

FIG. 21 is a flow chart illustrating an example of recruitment progress analysis.

FIG. 22 is a flow chart illustrating an example of a method for clinical trial protocol organization.

FIG. 23 is a flow chart illustrating another example of a method for clinical trial protocol organization.

FIG. 24 is a flow chart illustrating an example of a method for interactive clinical trial protocol organization.

FIG. 25 is a flow chart illustrating an example of a method for clinical trial protocol translation.

FIG. 26 is a flow chart illustrating an example of a high-level method for developing a clinical trial study.

FIG. 27 is a diagram depicting an example of a physician referral network utilized within the physician outreach processes.

FIG. 28 is a diagram depicting an example table structure to support the physician centric data model.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The following sections of this document provide a detailed description of example embodiments of systems and methods for selecting a clinical trial site, selecting an investigator (physician) for a clinical trial site, communicating and recruiting both patients and physicians for a clinical trial, and various underlying unique data structures and mechanisms for facilitating these activities.

### 1. Evidence-Based Site Selection

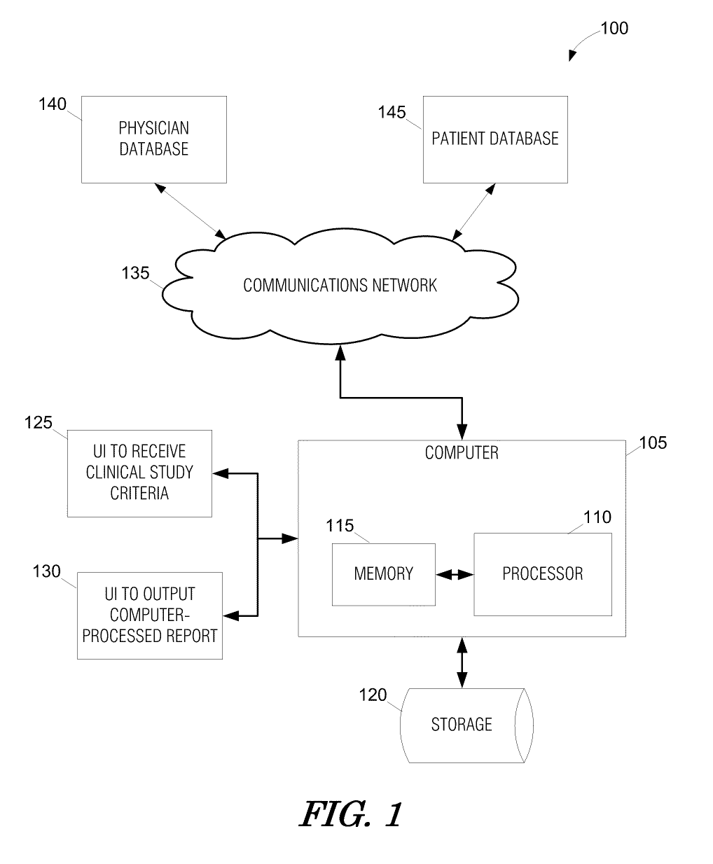

FIG. 1 is an example of a block diagram of portions of a system 100 for computer-assisted physician and patient recruitment for a clinical trial as well as clinical site selection (the system). FIG. 1 also includes portions of an environment in which the system is used. In the example of FIG. 1, the system 100 includes a computer 105 coupled to a communications network 135, such as the Internet. In this example, the computer 105 includes a processor 110 that executes or interprets instructions obtained from a machine-accessible medium, such as a memory 115 or storage 120. In this example, the system 100 includes one or more user interfaces, such as a user interface 125 to receive clinical study input criteria and user interface 130 to provide a computer-processed report, such as having information about suitable patient candidates, physicians, clinical trial sites, or facilities for use in the clinical trial.

In the example of FIG. 1, patient data can be obtained in different formats, such as from different data storages, represented here by the patient database 145, which may be associated with different business organizational entities that may not be concerned about the compatibility of data formats or sharing of patient data between such business entities. In an example, the organizational entity providing the computer-assisted patient recruitment contracts with other organizational entities to obtain the patient data, and such other organizational entities include, among other things, Independent Practice Associations (IPAs), Preferred Provider Organizations (PPOs), Health Maintenance Organizations (HMOs), Practice Management Systems (PMS) companies, Electronic Medical Records (EMR) companies and others.

In the example of FIG. 1, physician data can be obtained in different formats and from different data storages, which are represented here by a physician database 140. Example sources of physician data include medical practitioner databases, IPAs, PPOs, HMOs, PMSs, American Medical Association (AMA), various governmental agencies and others. In another example, the physician database 140 could also represent a proprietary collection of medical practitioner data which has been collected and filtered for use in clinical trial recruitment.

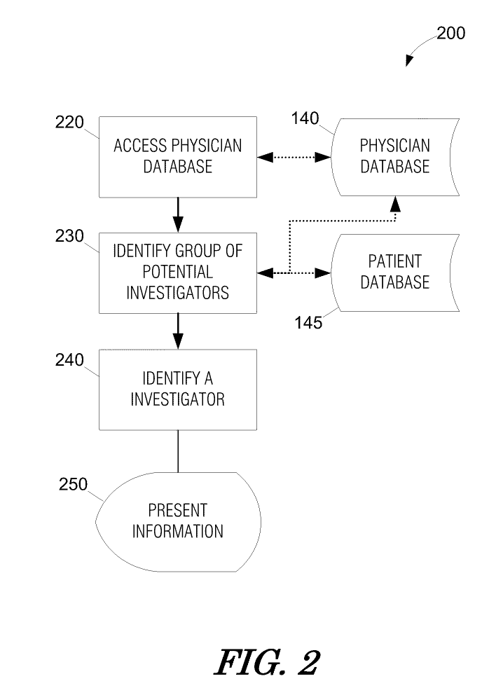

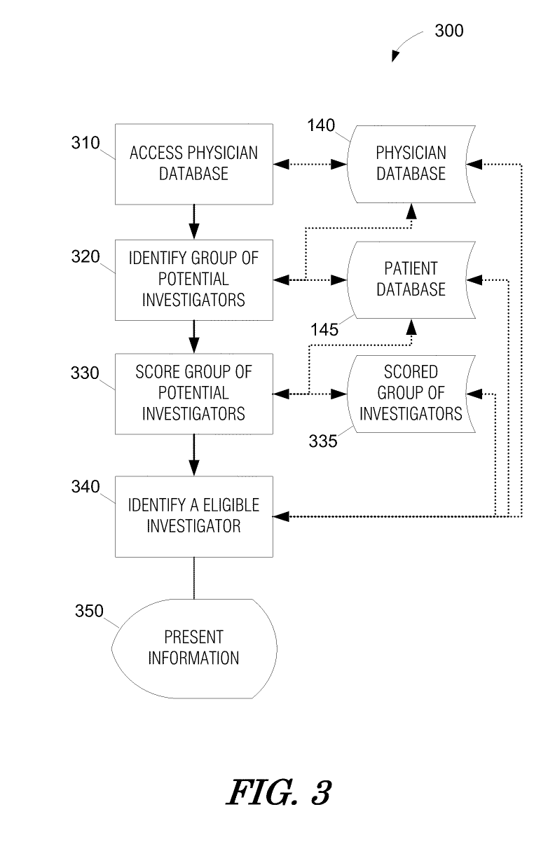

One important factor in a successful clinical trial is the selection and recruitment of the right investigator for a particular clinical trial site. Historically, clinical trial recruitment has been focused on patient recruitment with no emphasis placed on vetting the potential pool of investigators based on various criteria important to the success of a given clinical trial. FIG. 2 illustrates an example method for selecting an investigator (physician) for a particular clinical trial out of a pool of potential candidates. FIG. 3 illustrates another example of investigator selection incorporating information about patients eligible for the particular clinical trial into the selection process. The investigator selection process can also include the scoring and clustering mechanisms disclosed in the applications incorporated by reference into this specification, such as U.S. patent application Ser. No. 11/360,800.

The process 200 of selecting an investigator begins by accessing a physician database at 220. In an example, the physician database 140 is accessed at 220. At 230 the process 200 identifies a group of potential investigators from the physician database. In an example, identification includes looking for a particular specialty, limiting the geographic scope of search, or any other sponsor-defined criteria that can assist in narrowing the field of potential candidates to be investigators in a clinical trial. Identification can also include a filtering mechanism. For example, utilizing the Food and Drug Administration's (FDA's) blacklist, physicians who are ineligible to participate in clinical trials can be filtered out. In yet another example, the group of potential investigators consists of only those physicians who have eligible patients for the study or only those physicians who have a required piece of equipment in their office.

Once the universe of available physicians is narrowed to a group of potential investigators at 230, the process 200 can identify a suitable investigator at 240. This second identification takes one or more clinical trial sponsor-defined criteria into account in selecting an investigator from the group of potential investigators. Once the investigator is selected at 240, the process 200 moves to 250 where information regarding the selection process 200 is presented to a user. In an example, the presented information includes both the identified investigator and the group of potential investigators identified at 230. In another example, only the one or more identified investigators and associated data is displayed or reported to the end-user. In an example, associated data includes sponsor-defined criteria used to select the investigator. In another example, associated data includes information about the investigator such as specialty, clinic location, available office equipment, and patient statistics.

FIG. 3 illustrates another example of a method for identifying an investigator that includes accessing a patient database. The method 300 includes procedures for identification of a group of potential investigators 320, identification of an eligible investigator 340, as well as scoring 330. One skilled in the art would appreciate that information from a patient database 145 can be used in any or all of these points in the process. In another example, accessing the patient database includes a scoring or clustering mechanism operating on the patient data. Generally, patient clusters are groups of patients within a sponsor-defined distance. Scoring and clustering of patient data is described in detail in the previously filed applications referenced above, such as U.S. patent application Ser. No. 11/360,800. Once scored or clustered the analyzed patient data could be utilized to assist in the investigator selection process 340. For example, the group of potential investigators identified at 320 could be identified based on proximity to clusters (or a particular cluster) of eligible patients.

Like the process 200 illustrated in FIG. 2, the process 300 in FIG. 3 starts by accessing a physician database at 310. In an example, physician database 140 is accessed at 310. The process 300 continues by identifying a group of potential investigators at 320. In an example, identifying includes a filtering mechanism. In this example, physicians are filtered based on specialty to identify the group of potential investigators 320. Then the group of potential investigators can be scored 330 based on various factors including physician characteristics, patient demographics, or sponsor-defined criteria for the targeted clinical trial to produce a group of scored investigators 335. In an alternative example, the scoring 330 is done on the entire universe of physicians, in this example identifying a group of potential investigators 320 returns all physicians in the physician database.

Once a group of scored investigators 335 is available, the process moves to identifying at least one eligible investigator 340. The eligible investigator is identified utilizing sponsor-defined criteria for the targeted clinical trial. The sponsor-defined criteria are compared or analyzed against information including the investigator scores, eligible patent data and other relevant physician characteristics.

An example investigator selection that follows the process 300 depicted by FIG. 3 utilizes a physician specialty to identify a group of potential investigators and then scores the physicians on proximity to eligible patient clusters and propensity to administer a particular procedure for treatments similar to the targeted clinical trial. Limiting the group of potential investigators to only those physicians who are board certified to conduct the targeted specialty reduces the amount of processing necessary to produce likely physician candidates.

In an example, the scoring process 330 weighted proximity to eligible patient clusters and propensity for a particular procedure equally. However, for some clinical studies, proximity to patients might be more important. The system allows for the sponsor to select weighting factors on any criteria used in the scoring or identification processes. This multi-dimensional scoring process allows the system to pinpoint investigators with the targeted combination of attributes for the clinical trial.

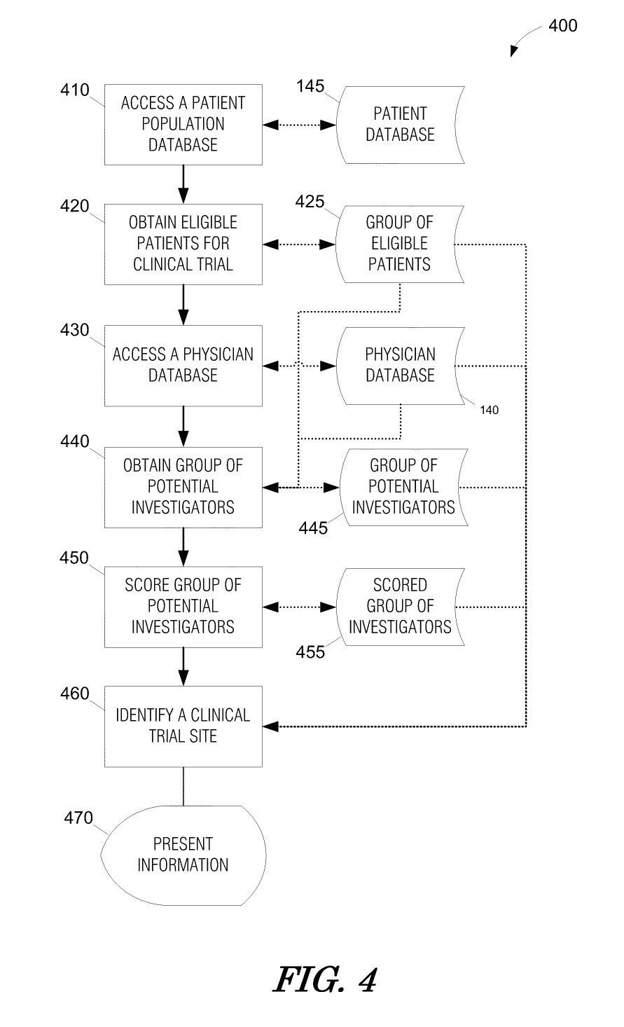

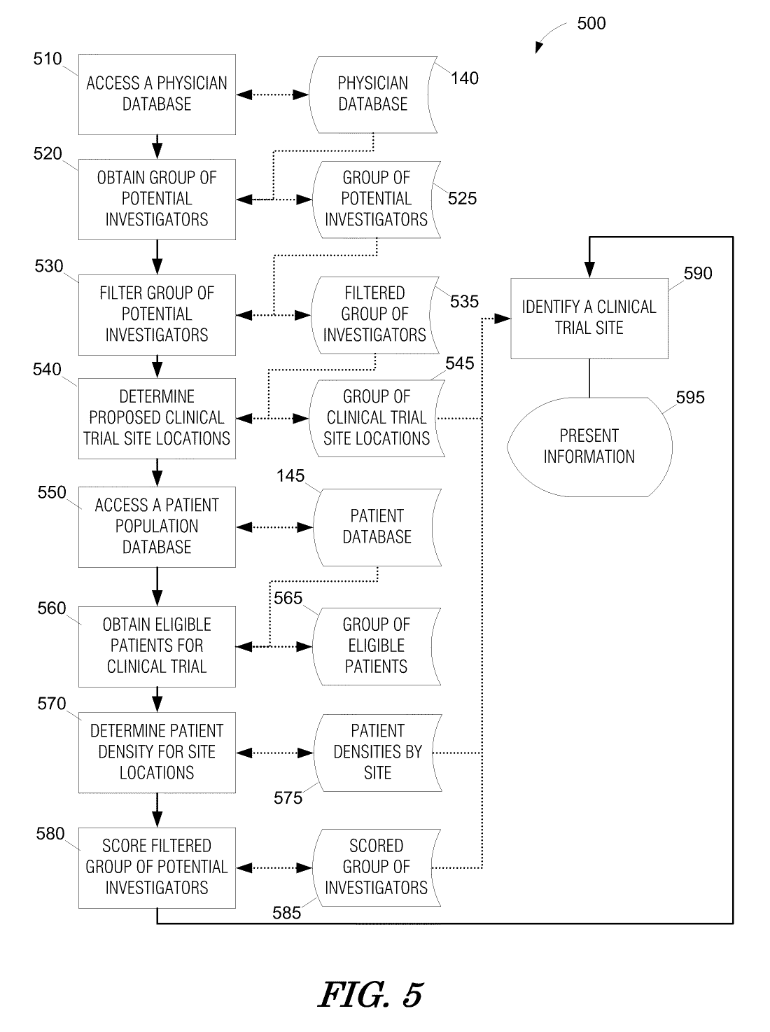

FIGS. 4 and 5 depict two example processes for selecting clinical trial sites that each utilizes information including physician, patient and geographic data together with sponsor-defined criteria for the targeted clinical study to select suitable locations to conduct the study.

FIG. 4 illustrates an example process for identifying at least one clinical trial site. The process begins at 410 by accessing a patient population database 145. From the patient population database 145 a group of eligible patients 425 is obtained at 420. In an example, obtaining the group of eligible patients 420 includes a filtering mechanism. For example, eligible patients can be obtained by filtering the patient database based on a sponsor-define criteria. Sponsor-defined criteria include diagnoses, age, location, or other health related data. Next the system accesses a physician database at 430.

At 440, the system utilizes information including the group of eligible patients 425 and the physician database 435, to obtain a group of potential investigators 445. In an example, obtaining the group of potential investigators 445 could include clustering the group of eligible patients into geographic locations and filtering physicians based on a sponsor-defined proximity from eligible patient clusters. In an alternative example, obtaining the group of potential investigators 445 can include filtering physicians based on a sponsor-defined physician characteristic required for the clinical trial. In yet another example, obtaining the group of potential investigators utilizes a combination of criteria focused on either patients or the physicians required for a clinical trial. Like other procedures which limit the universe of potential physicians or patients, a scoring and thresholding process can also be utilized. For example, a physician could be scored based on her number of patients eligible for the clinical study and then a threshold score can be applied to eliminate physicians without sufficient eligible patients.

After a group of potential investigators 445 is obtained, the process 400 continues by scoring the group of potential investigators at 450 to produce a group of scored investigators 455. The scoring process for potential investigators can include scoring similar to that described in the previously filed applications referenced above, such as U.S. patent application Ser. No. 11/360,800. Additionally, scoring of potential investigators can be done based on physician specific characteristics including proximity to eligible patients (or patient clusters), physician qualifications or experience, preference for a particular procedure, office equipment, office staff profile, referral patterns or even proximity to public transportation systems.

Once the potential investigators are scored at 450, the process 400 moves on with the system 100 identifying a clinical trial site at 460. In an example, the identification 460 can utilize inputs from the scored group of investigators 455, the group of potential investigators 445, the physician database 435, or the group of eligible patients in identifying a clinical trial site. Identification at 460 can include operations such as clustering or scoring on the input data. In an example, identifying a clinical trial site can include clustering the eligible patients, scoring the group of potential investigators based on proximity to patient clusters and office staff profile. The identification at 460 can select clinical sites that include a substantial number of potential investigators within a sponsor-defined proximity to the patient clusters and having the required staff profile.

The clinical trial site selection process depicted in FIG. 4 can conclude by presenting information regarding the identified clinical trial site to the user at 470. In an alternative example, the process can conclude by presenting a series of clinical trial sites that meet the sponsor-define clinical trial criteria at 470. In either case the system is capable of including detailed patient, physician and general demographic information regarding the identified site. In an example where multiple sites are identified the system allows for the user to select from the identified site for reporting purposes.

FIG. 5 illustrates another example clinical trial site selection process 500 tailored towards clinical trials that place great emphasis on investigator capabilities. An example situation can include the sponsor-defined criteria for the investigator being very restrictive, but the eligible patient population is large.

This example selection process begins by accessing a physician database 140 at 510. A group of potential investigators 525 is obtained from the physician database 140 at 520. Obtaining the group of potential investigators 525 utilizes sponsor-defined clinical trial criteria to select from the universe of available physicians. An optional filtering process 530 allows the group of potential investigators 525 to be further reduced based on additional sponsor-defined clinical trial criteria.

The process 500 continues by determining a group of proposed clinical trial site locations 545 based on the group of potential investigators 525 or the filtered group of investigators 535 at 540. In an example, the filtered group of investigators is clustered to determine proposed clinical trial site locations. In another example, the location of each investigator in the group of potential investigators 525 is compared to all major metropolitan areas with a population over two million. In this example, the group of proposed clinical trial site locations 545 comprises a group of major metropolitan areas that contain more than a sponsor-defined threshold of potential investigators within a sponsor-defined distance.

Next the process continues by accessing a patient population database 145 at 550. The information in the patient population database 145 is used to obtain a group of eligible patients based on sponsor supplied criteria for the clinical trial at 560. Patient densities for proposed clinical trial site locations can be determined at 570 and stored as patient density information 575. Patient density information 575 is saved for use later in identifying a clinical trial site at 590.

Before the clinical trial sites are identified, the process 500 scores the filtered group of potential investigators at 580 and saves the information in a group of scored investigators 585. At 590, information such as the group of clinical trial site locations 545, patient densities 575, and the scored group of investigators 585 is used to identify a clinical trial site. In addition to the information mentioned, sponsor supplied criteria will also typically be factored into the identification process at 590. At 595, the process 500 concludes by presenting information on the identified clinical trial site. In an additional example, the presentation of information can include the group of proposed clinical trial site locations 545, patient densities 575, and the scored group of investigators 585. In another example, the presentation can include additional scoring information based on the sponsor supplied clinical trial criteria.

### A. Example Commercial Embodiment

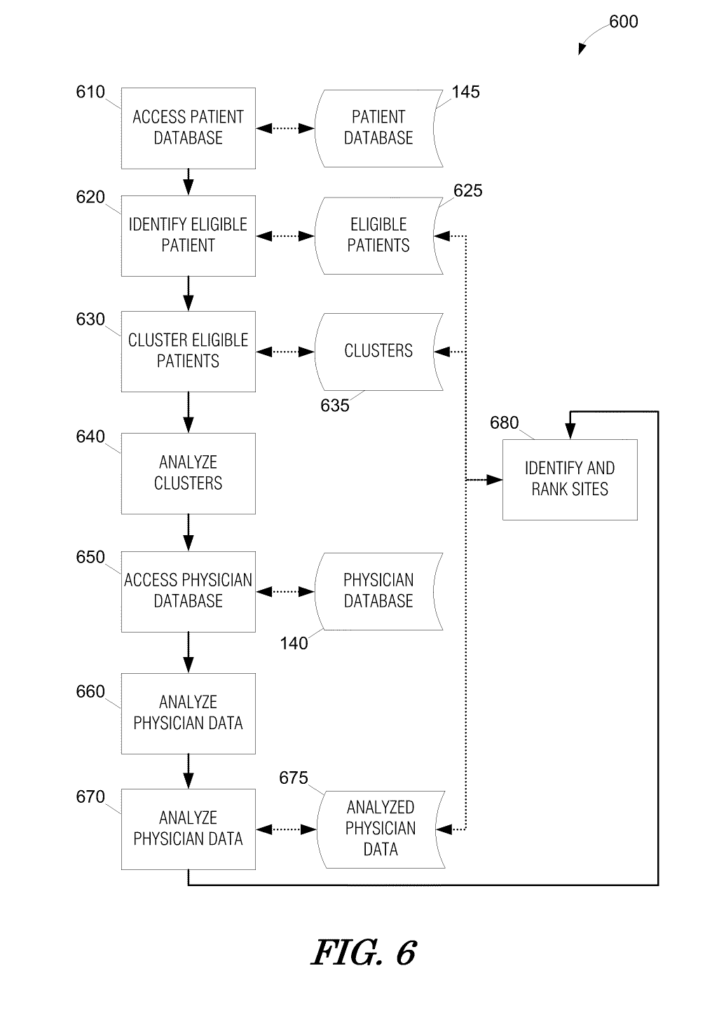

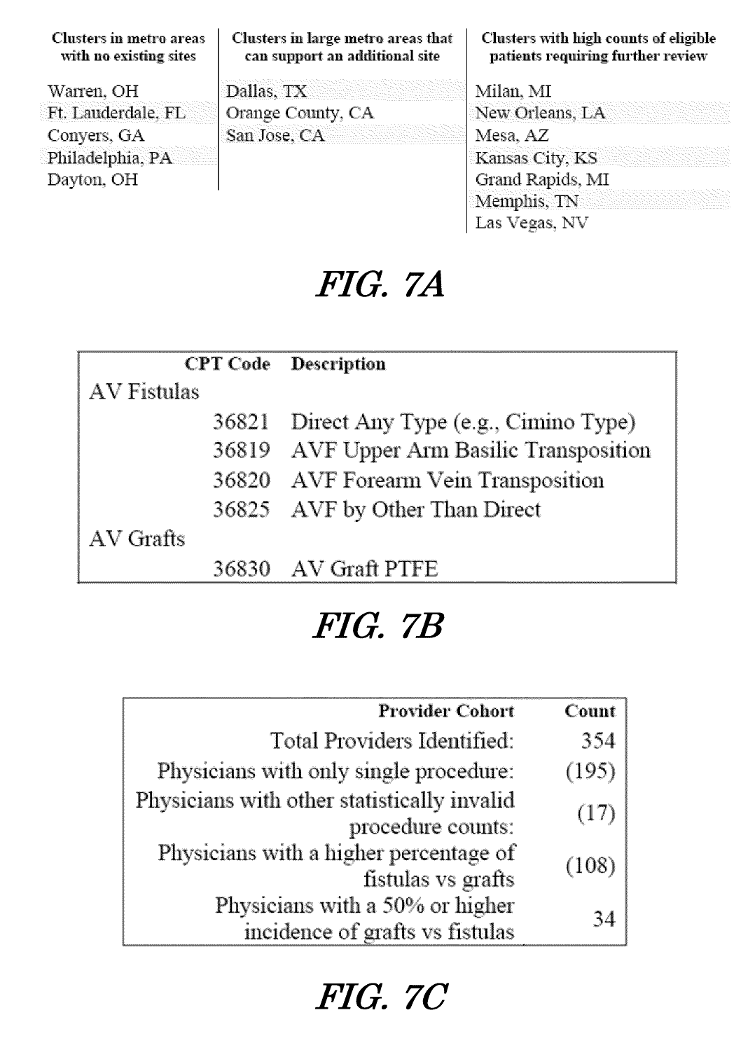

FIGS. 6-12 illustrate an example commercial embodiment of the evidence-based site selection process described above. FIG. 6 illustrates the basic process followed by this embodiment, while FIGS. 7-12 illustrate some of the available outputs and reports presented to the clinical trial sponsor. In this example, evidence-based site selection can identify clusters of eligible patients, physician treatment histories and practice data, proximity relationships to existing sites and metropolitan areas as well as specific facilities, investigator credentials, or other unique properties of the envisioned study.

The system 100 evaluates information relative to a clinical study's needs, and the sponsor's goals for site development and recruitment. The system 100 can make recommendations on geographic areas, and in some cases, specific physician practices, where productive sites have a high likelihood of achieving highly productive enrollment levels.

### Clusters of Candidates:

The process 600 identified and evaluated clusters of eligible candidates that were not in proximity to existing clinical trial sites (see FIG. 6, items 610, 620 and 630). In this particular example, fifteen significant clusters of candidates were identified. All identified clusters had the patient density to support productive investigative sites for this study, based on sponsor supplied clinical trial criteria. All clusters were scored and ranked 640 to produce reference points comparing the potential value of clusters to one another.

The process 600 evaluation of these clusters falls into three distinct categories: clusters in Metro Areas with no current sites, clusters in large metro areas that can support additional sites, and clusters with high counts of eligible patients that require further review due to additional information needed on other factors (such as suitably qualified investigators in the area). FIG. 7A illustrates example output on the evaluation of patient clusters.

### Physician Preference for Certain Procedures:

To better target potential investigators for this particular clinical trial study, the system 100 can perform an analysis identifying physicians performing vascular access on ESRD patients with a higher incidence count of grafts versus fistulas. Given a particular set of input data, the system 100 can conclude that of all providers performing vascular access procedures, 10% indicate an incidence of 50% or more graft procedures.

Physicians identified as having a high propensity for graft procedures can be factored into the cluster scoring so that clusters where such physicians were present scored higher.

At the sponsor's request, the system 100 can analyze the incidence of a particular procedure, such as vascular access procedures, in the data universe (e.g. patient and/or physician databases) to identify vascular surgeons performing a higher percentage of grafts vs. fistulas on ESRD patients.

This measurement results in identification of physicians who perform a 50/50 or higher percentage of grafts versus fistulas. The system 100 can then automatically engage a physician outreach effort targeting these physicians to become principal investigators (PIs) or subordinate investigators (sub-I's) for the particular clinical trial study. The physician outreach (physician communications) portion of the system is described in more detail below.

The system 100 can analyze the most recent three months of data for each provider who has performed either a graft or a fistula on any ESRD patients targeted in this study. In another example, the system 100 can analyze a sponsored-defined timeframe thought to be relevant for the particular study. For each such physician, the system 100 can measure the number of vascular access procedures performed, and what percentage grafts or fistulas represented of the total vascular access procedures identified. FIG. 7B illustrates how the procedures analyzed can be classified.

This particular analysis indicates that about 10% of total providers identified had a higher than average percentage of grafts performed, and yielded a classification of providers as illustrated in FIG. 7C.

The findings of this particular study can be summarized by the system 100 as follows:
354 providers were identified who performed any of these procedures on the targeted patients.
Of the 354, 195 physicians indicated only one procedure for this time period.
These were deemed statistically irrelevant and discarded for this analysis.
Of the 354, 17 physicians indicated two total procedures, one graft and one fistula for each of the 17 physicians. These measures were also deemed statistically inconclusive and discarded for the analysis.
108 physicians indicated a higher than 50% ratio of fistulas vs. grafts (additional statistics on this cohort is available upon request by the sponsor).
The remaining 34 physicians indicate a 50% or higher percentage of grafts versus fistulas with a statistically reliable sampling of procedures.

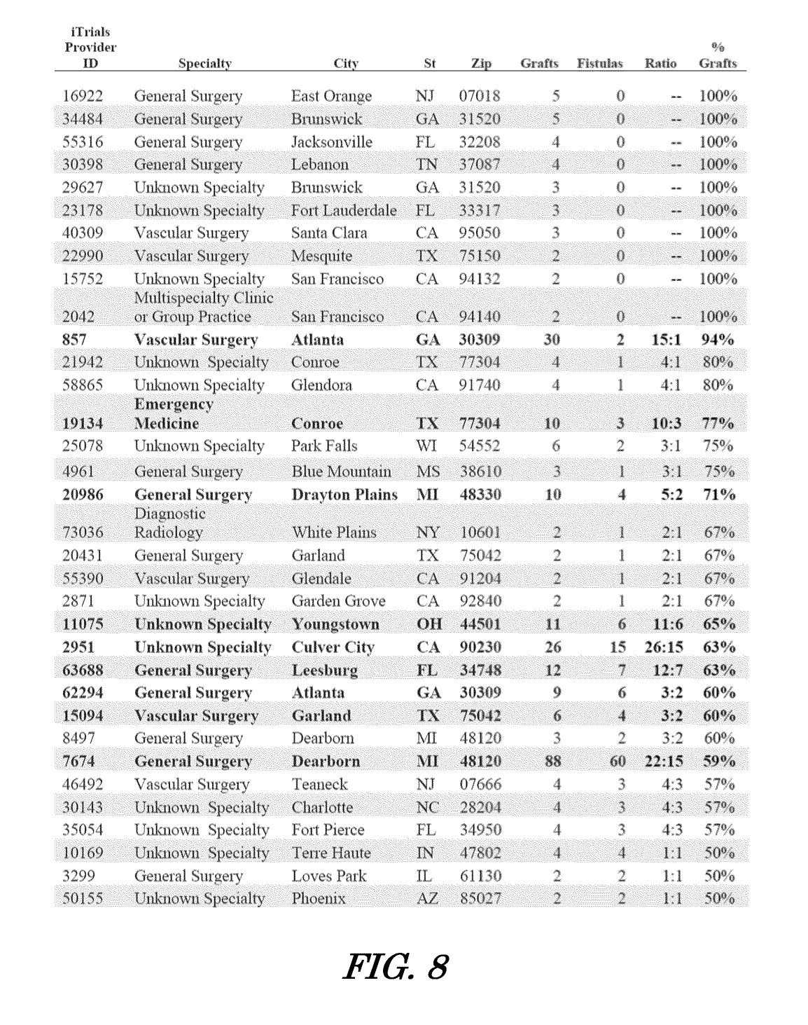

FIG. 8 illustrates output from the system 100 that can display a table listing the thirty-four physicians who performed a higher percentage of graft procedures as compared to fistulas and indicates the number of grafts and fistulas each performed. The physicians listed in bold indicate the physicians of highest target value based on graft percentage, procedure volume, or both. The system 100 can incorporate these findings into the cluster analysis that follows, as clusters with high graft percentage physicians are scored higher than clusters without physicians who are known to have a high graft percentage.

The system 100 is capable of Candidate Cluster Analysis, which defines geographic groupings of eligible candidates. This data enables trial sponsors to select sites based on evidence of available patients, and it addresses other questions and issues regarding patient populations. For this particular example study, the cluster parameters input into the system 100 include:
1) The number of candidates used to define a cluster: 200
2) The required geographic proximity of the candidates to one another: 8 miles
3) Added weight was given to clusters within a sponsor-define proximity of a major metro area
4) Added weight was given to clusters with physicians previously involved in vascular access for ESRD patients and who have a confirmed preference for grafts vs. fistulas.

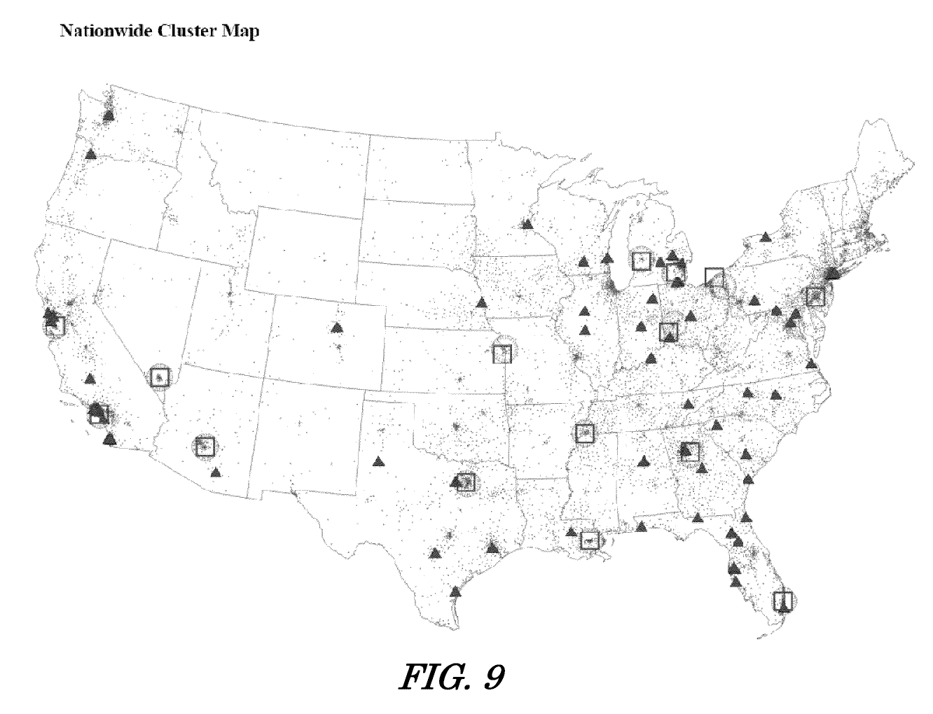

FIG. 9 illustrates an example output from the system 100 for candidate (eligible patient) cluster analysis as described above.

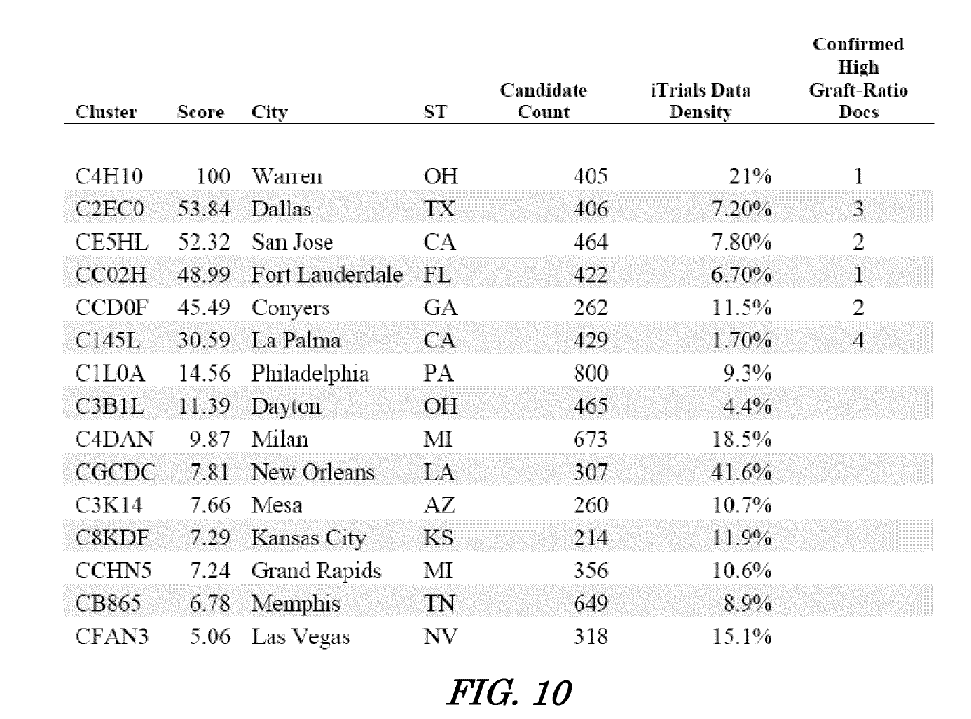

FIG. 10 depicts an output from the system 100 that lists logical clusters of eligible candidates as identified by the system 100 through the analysis described above. A ‘logical cluster’ is a group of eligible candidates within a predefined distance of each other (e.g. 8 miles), and with a total candidate count exceeding a defined critical value (e.g. 200). Each logical cluster can also be scored on criteria such as proximity to existing and proposed clinical trial sites and major metro areas, total candidate count, and the average scores of the candidates composing the cluster. In addition, cluster analysis can add a scoring component to reflect evidence of physicians who are confirmed to prefer grafts rather than fistulas for ESRD patients, and to reflect the magnitude of that preference.

### System Output—Cluster Details:

For each potential clinical trial site (also referred to as a Candidate Cluster) the system 100 can produce detailed summary information including:

Cluster Score

Candidate Count,

Nearest Metro Area,

Nearest Site,

Zip codes of candidates within the cluster, and

Overview of providers treating candidates within the cluster.

Maps can illustrate the cluster location relative to existing sites and metro areas. Several comparative charts are included in each Candidate Cluster Detail, helping the reader to assess the cluster's qualities as compared to all other clusters.

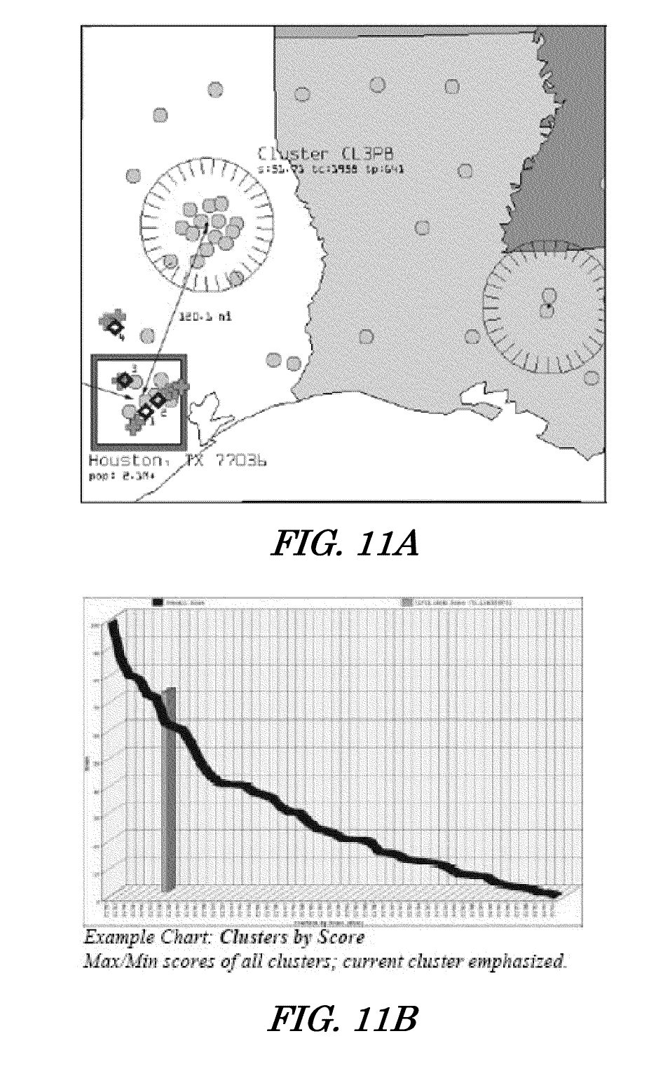

FIG. 11A is a cluster map illustrating detailed output from the patient and physician recruitment system. A Candidate Cluster Map is a cluster map that defines the geographical region containing a ‘cluster’ of eligible candidates meeting certain criteria. Each cluster can be scored on several criteria, including minimal proximity of candidates composing the cluster, and a total candidate count above a defined threshold. The map can display the region surrounding the cluster, as well as locations of the nearest potential trial sites, facilities, major metro areas, or other parameters.

FIG. 11B is a chart depicting a selected cluster's score relative to all scored clusters. A cluster's overall score can be the normalized composite value of all scoring factors, including candidate and caregiver counts, site proximity, metro proximity, and other factors. Generally, the system operates where the higher the cluster score, the more valuable the cluster. The Clusters by Score graph, FIG. 11B, denotes the current cluster as a vertical bar against a line graph of normalized scores for all clusters identified in the study. All scores are normalized (between 0%-100%).

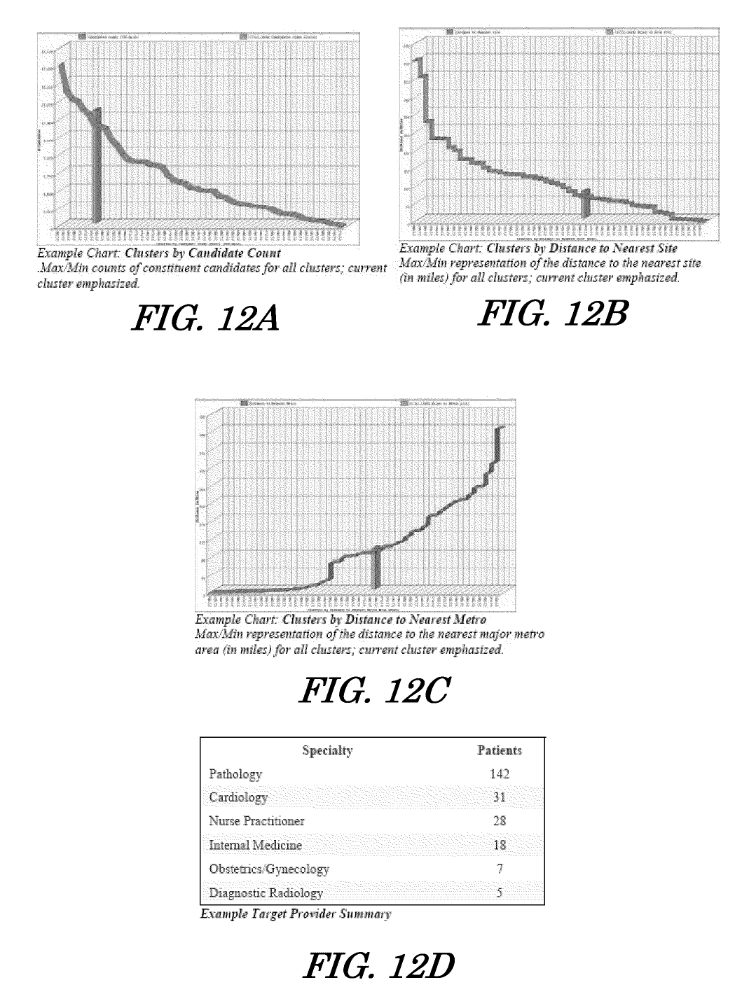

FIG. 12A illustrates clusters by Candidate Counts output. In this graphic presentation, a cluster is represented simply in comparison to a descending line graph of candidate counts for all clusters. Other criteria (e.g. number of caregivers involved, proximity to metro areas, etc.) do not influence this measurement.

FIG. 12B illustrates example output for Clusters by Distance to Nearest Site. In this example, each cluster is ranked solely on proximity to predefined study sites. Clusters can be represented in declining scores reflecting descending mileage from the nearest existing trial site. Note that clusters farther away from a designated site will score higher than sites closer to a designated site, as candidates within this cluster are less well served by existing sites and the cluster is therefore a more worthy potential site location.

FIG. 12C illustrates example output of Clusters by Distance to Nearest Metro. Clusters are represented in ascending order of distance (in miles) to the nearest major metro area. This chart indicates proximity to resources such as major hospitals, well developed public transit, and dense media and print markets. Close proximity to a major metro area (e.g. Pop >500,000) causes a cluster to score higher.

FIG. 12D depicts example output of a summary of Physician Data analyzed for this particular study. For this study, the system has counted the number of potential referring physicians by specialty. Also we have indicated data on which physicians have a confirmed preference for grafts versus fistulas in ESRD patients.

### Cluster Detail:

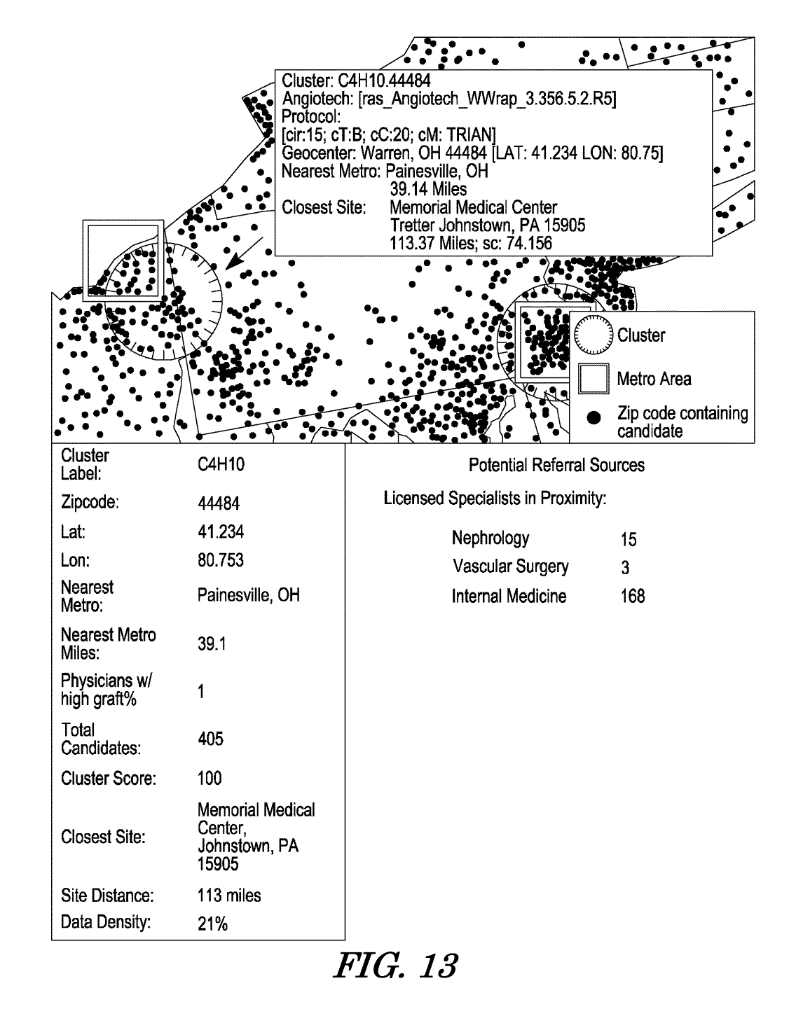

FIG. 13 illustrates the graphical portion of the cluster detail output available from the system. In this particular example, the Vascular Access Incidence Analysis found one physician near this cluster performing vascular access on ESRD patients.

The physician identified meets the target preferences for PIs in this Vascular Wrap study. This physician shows a nearly two-to-one incidence of grafts vs. fistulas. This physician would be contacted by the system through the outreach communication mechanism and presented with the PI opportunity.

FIG. 13 illustrates output on a cluster in Warren, Ohio, which has ˜386,000 persons in the surrounding area. The Data Universe reflects 21% of total population within 8 miles of this cluster. This is higher than the overall data penetration of 17% nationwide, represented in this version of the Data Universe. Data analysis at this level is statistically significant, at a higher-than-average degree of confidence than for other U.S. cities.

The system 100 can provide cluster summary information to the sponsor. An example summary includes information such as an indication that the cluster, Warren, Ohio, stands out as a potential site location because:
403 qualified patients located within 8 miles of a potential investigator
The potential investigator strongly prefers grafts rather than fistulas (by nearly 2-to-1), and
The cluster is well over 100 miles from an existing site.
   Being nearly 40 miles from the nearest metro area, these patients are relatively isolated. Remarkably, Warren has nearly as many eligible candidates (403) as Dallas (406), with a population less than 15% that of Dallas (386,000 vs. 2.7 million). This concentration of eligible ESRD patients is far out of proportion to what one would expect based on population density alone. The Warren cluster received the highest Overall Cluster Score in this particular example study, suggesting all factors (clinical fit, site/metro distance, physicians with high graft %) scored highly.

### 2. Outreach Communications Process

The physician outreach communication process is a method of physician recruitment and enrollment process associated with the system 100 discussed above. Portions of the following process are or could be automated within the computerized system 100 depicted in FIG. 1. Other portions of the system are computer-assisted, but are not fully automated.

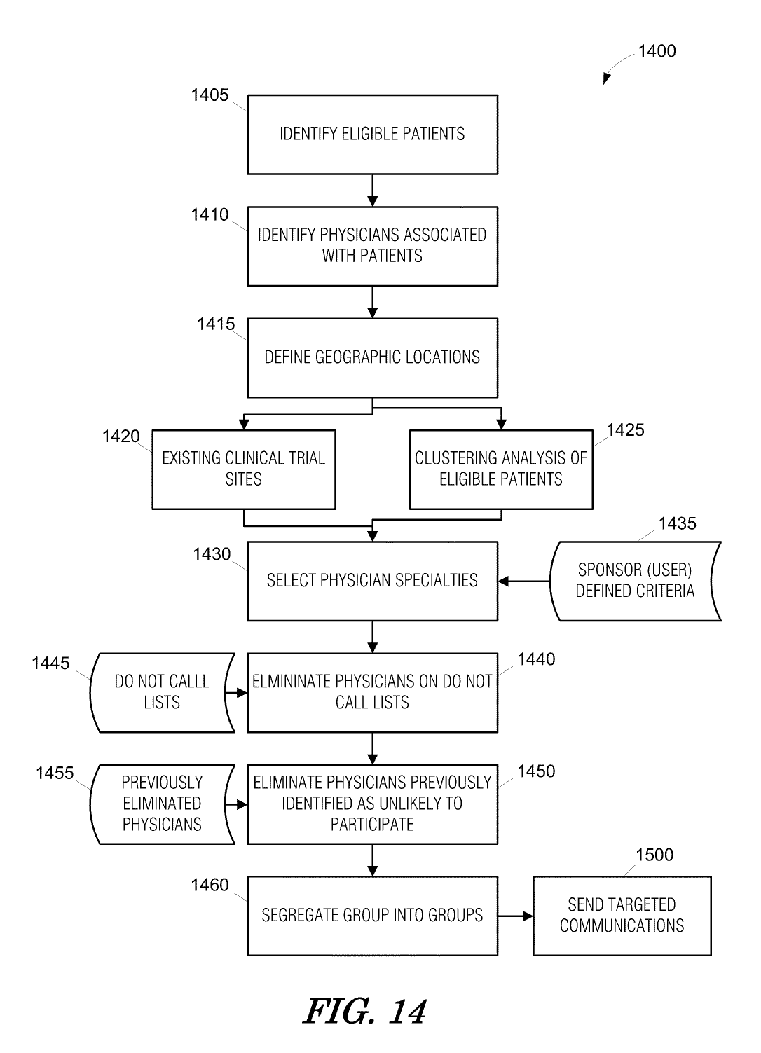

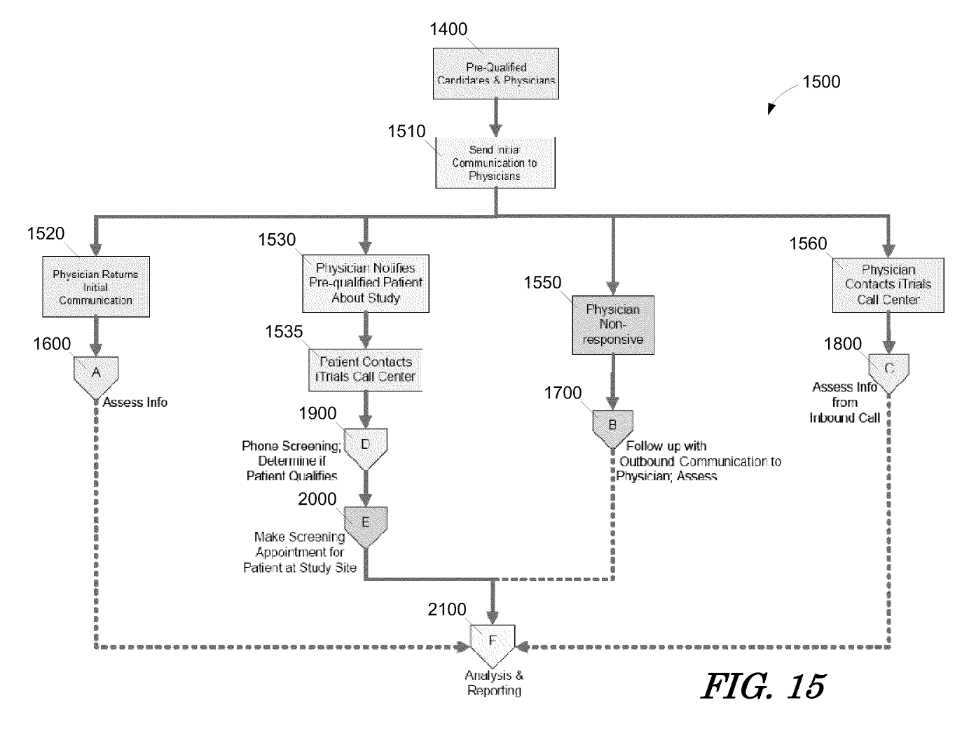

FIG. 14 illustrates an example process 1400 leading into the outreach communication process illustrated in FIGS. 15-21. Process 1400 begins by identifying eligible patients at 1405. At 1410 physicians associated with the eligible patients are identified. Geographic target locations and clinical trial sites are defined at 1415. In this example, clinic trial sites are selected either by utilizing existing clinical trial sites 1420 or by a clustering analysis of the eligible patients 1425. In another example, sites could be found by doing a clustering analysis on the physicians or merely selecting major metropolitan areas (with patient densities exceeding a sponsor-defined minimum).

The process 1400 continues at 1430 by selection of required or desired physician specialties, this is a sponsor defined criteria. Process points 1430, 1440 and 1450 include filtering procedures, reducing the number of potential physicians the system will initiate communications with. In an example, at 1440, all physicians who have placed themselves on do not call lists will be eliminated. In another example, an additional filtering procedure can be used removing all physicians on the FDA's blacklist, a list of physicians who are not allowed to participate in clinical trials. At 1450, the process 1400 accesses stored information on past interactions with physicians to determine if there remains any on the list that have been unresponsive or who may have asked not to be contacted in the future. The collection of previously eliminated physicians 1455 can also include physicians with out-of-service phone or fax numbers, incorrect e-mail addresses, or out-of-date physical addresses.

Finally, process 1400 concludes by segregating the group of physicians still included, not eliminated in any of the filtering procedures, into waves at 1460. For the purposes of this application a wave is nothing more than another term for group. The waves can be segregated based on geography, by specialty or simply by randomly grouping physicians. Once the group of physicians has been split up into waves, the process 14 transfers to process 1500 illustrated in FIG. 15.

FIG. 15 illustrates an overview of an example process for physician and patient outreach communications. The process 1500 begins by utilizing the output of process 1400 to send out initial communications to the selected physicians at 1510. This initial communication can be done via automated facsimile (FAX), e-mail, voice, or physical mailing. In an example, the system 100 outputs the necessary information for manual communications to be initiated by the trial sponsor or a third-party organization. Regardless of how the initial communications are handled, the remainder of the process concerns managing what happens after the initial communications, such as follow-up, return communications and screening.

After the initial communication is sent, the process 1500 continues down one of four paths based on each individual physician's response to the communication.

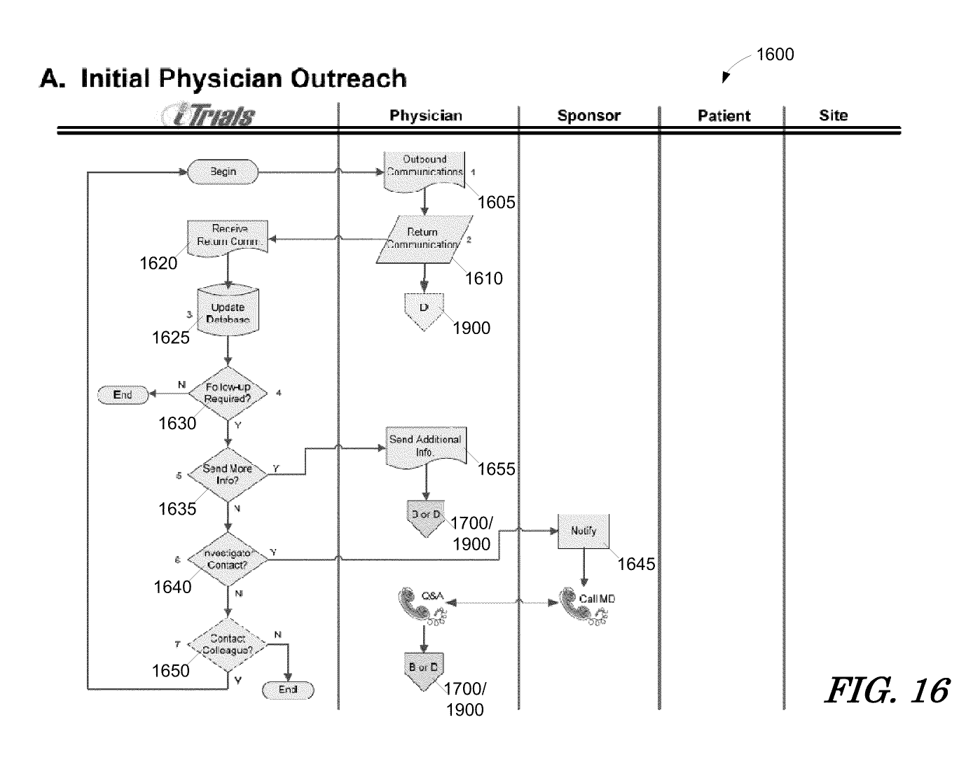

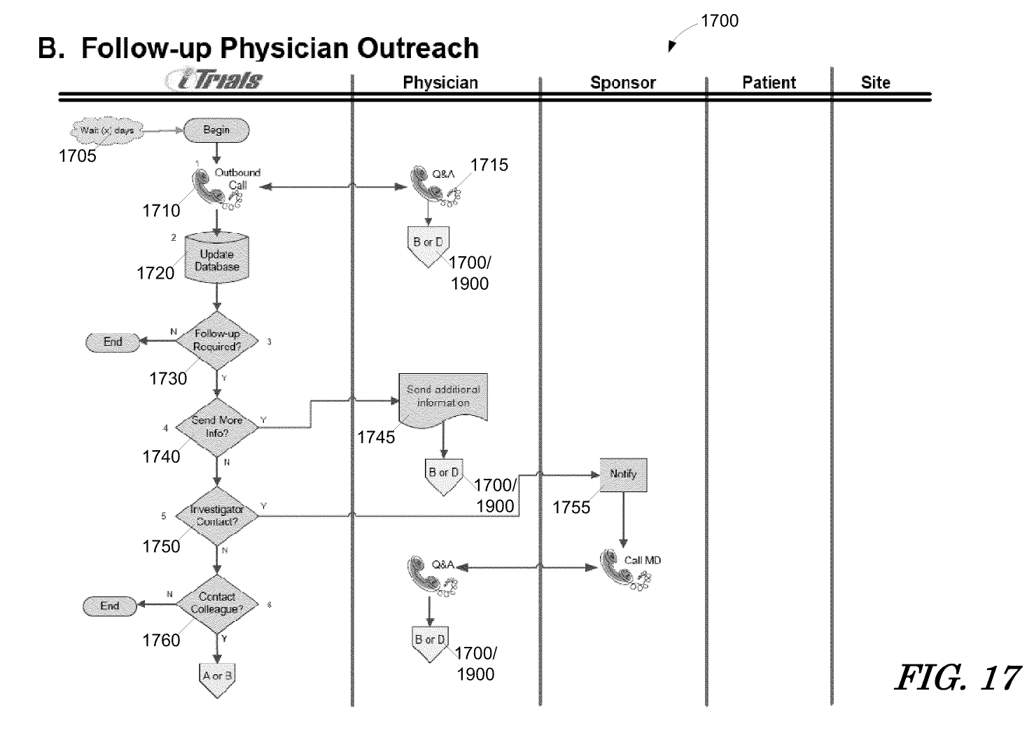

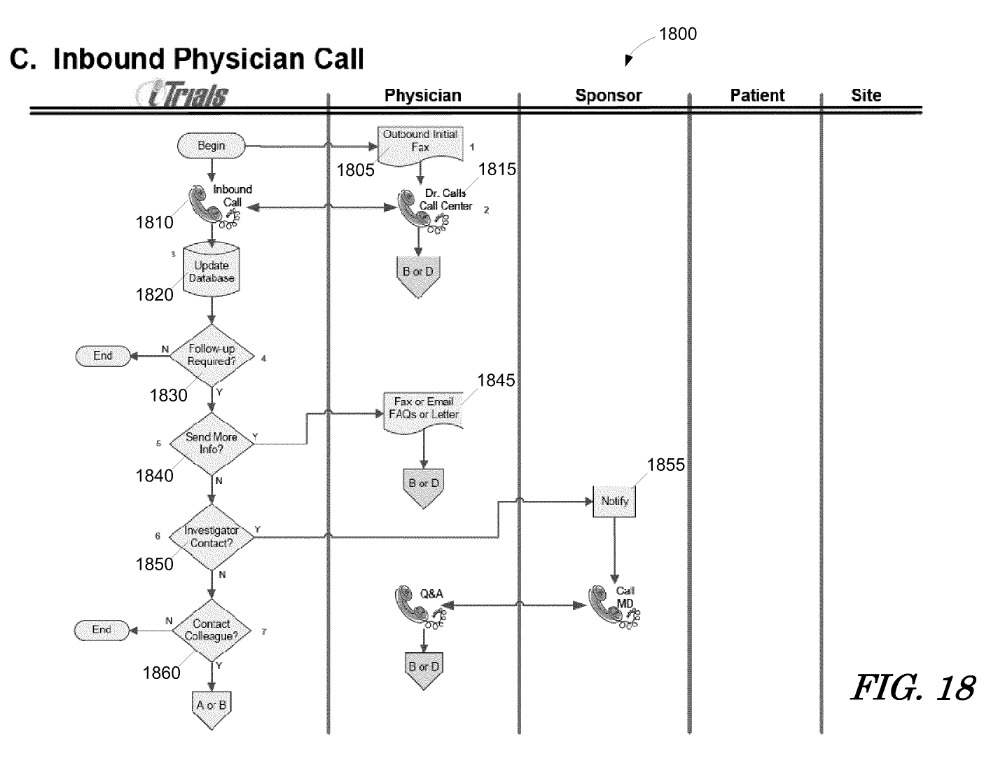

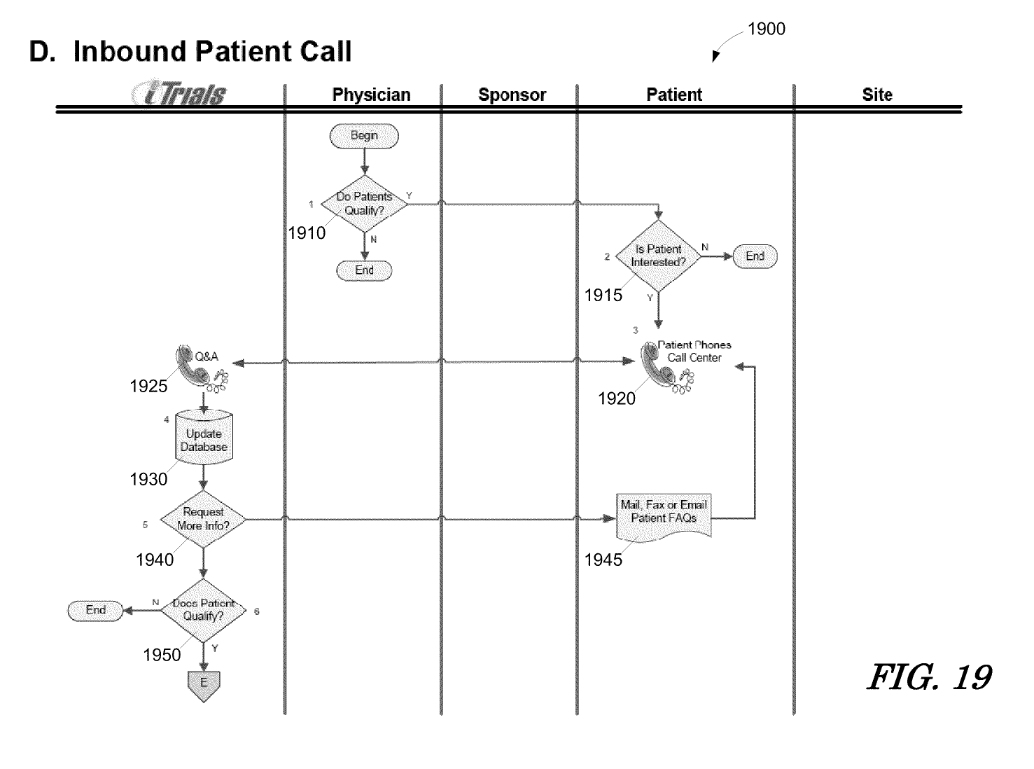

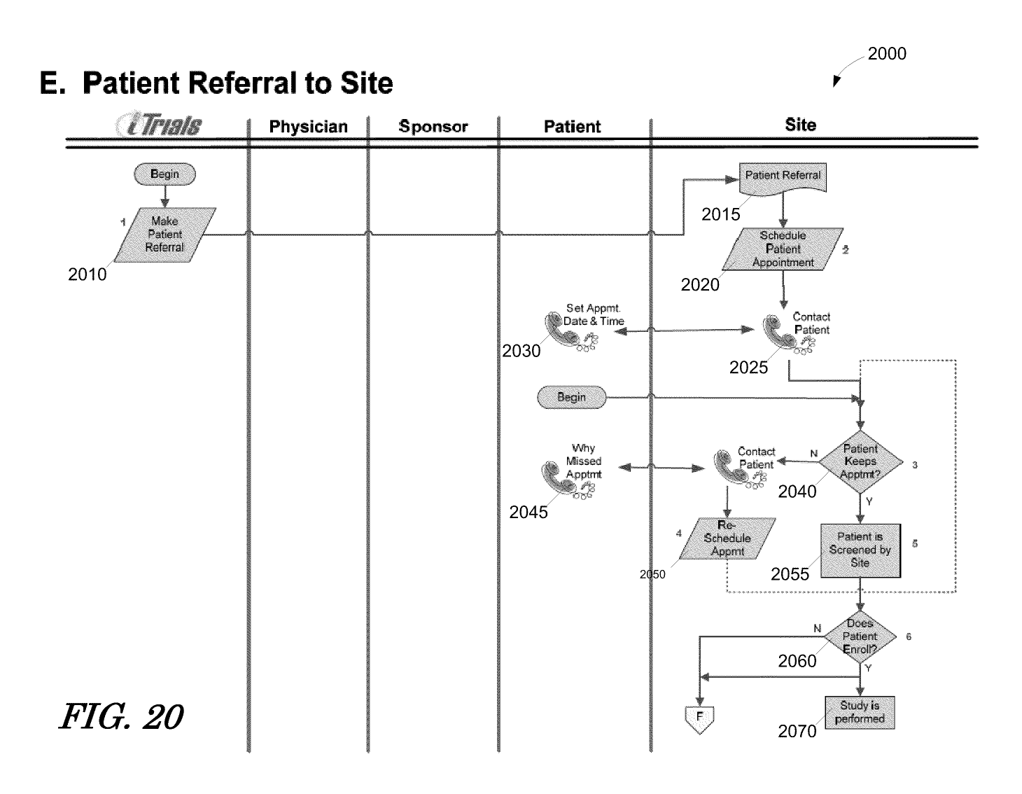

If the physician returns the initial communications the process continues at 1520 by transferring control to initial physician outreach; an example of physician outreach is described in FIG. 16. If the physician notifies a pre-qualified patient about the study the process continues at 1530. If the patient contacts the sponsor or third-party trial management organization, control is transferred to inbound patient call handling, an example inbound patient call handling process is illustrated in FIG. 19, and then on to patient referral, an example patient referral process is illustrated in FIG. 20. If the physician is non-responsive to the initial communications, then the process continues at 1550 with control transferring to physician follow-up, an example of the physician follow-up process is illustrated in FIG. 17. Finally, if the physician contacts the sponsor or third-party trial management organizations call center, control is transferred to inbound physician call handling, an example inbound physician call handling process is illustrated in FIG. 18.

### Initial Physician Outreach:

FIG. 16 illustrates an example of initial physician communication and response via FAX. In another example this process 1400 could be conducted via e-mail or interactive web-based forms. In yet another example the process 1400 could be conducted via automated interactive voice-response (IVR) systems.

The process begins with the physician receiving the initial FAX communication regarding the proposed clinical trial at 1605. After receiving the initial FAX, the physician returns the FAX-back form at 1610. The physician may then go on to process 1900, an example is illustrated in FIG. 19, contacting an eligible patient about the study.

Process 1600 continues with the system receiving the FAX-back form from the physician at 1620. The system then extracts information from the physician communication and updates the database at 1625. In an example, database updates include non-responsive or incorrect responses or physicians with no eligible patients (contact information is confirmed). In an example where the physician has no eligible patients, records are updated to ensure that no additional contact is made with this physician regarding this specific clinical trial.

Physician follow-up requirements are determined at 1630, based on information gathered from the physician communication at 1625. If no follow-up is required then processing continues at 1640. If follow-up is indicated, then the system sends (or prompts operators to send) additional information to the physician at 1655. Depending on the specific follow-up actions required processing transfers to either process 1700 or process 1900. In an example where the physician requested a phone call, processing transfers to process 1700. In another example where the physician contacted an eligible patient processing may transfer to process 1900.

At 1640 the system 100 can determine if the physician requested contact with the sponsor (or the study's lead investigator). These requests cause the system 100 to notify the sponsor at 1645 of the request. From here, the sponsor may contact the physician directly or have the study's lead investigator contact the physician.

Finally, if the physician indicated on the fax-back form that a colleague may be interested in the study, the system can utilize this contact information to begin a new outbound communication, looping back to 1605. The new outbound communication can include colleague referral information. The system 100 may also treat this process differently if the indicated physician has already been sent an initial communication in a previous process (or wave of outbound communications).

Referral and physician relationship information may also be stored for use in network diagrams and future research.

### Physician Follow-Up Communications:

FIG. 17 illustrates an example of the follow-up physician communication process 1700 in which the system 100 makes follow-up contact with the physician or prompts the operator to make the contact. In an example, the system 100 is configured to wait a certain number of days before beginning 1705. Once under way, the first operation at 1710 is to make an outbound communication attempt to the target physician. In this example, it is an outbound phone call at 1710. In another example the outbound communication can be an e-mail or automated FAX communication.

If the outbound communication 1710 is received 1715, the system or operator collects information through a series of questions and answers. Additionally, the system 100 or operator can provide the physician with additional information on the targeted clinical trial. In another example, receiving the response at 1715 can be done via an interactive web-page or IVR system.

The information collected from the physician at 1715 is then loaded into a database (or other repository accessible to the computerized system) at 1720. The process 1700 then analyzes the collected data and determines what sort of additional follow-up should be scheduled or initiated immediately. At 1740 the process 1700 determines whether more information should be sent out based on the physician's inputs at 1715. If more information was requested it is sent out at 1745. Depending on the physician's communication preference, the requested information (e.g. Physician FAQs, Sample Patient Letter, or other clinical trial related materials) can be faxed, e-mailed or mailed to the physician. After a sponsor-define number of days delay, this process 1700 can be initiated again.

Next at 1750 the process 1700 determines if the physician requested contact with the study's lead investigator. If contact with the study's lead investigator was requested, the sponsor is notified at 1755. These requests will be sent to the Sponsor's Lead Investigator, so that he/she may contact the physicians directly. This physician-to-physician communication is designed to answer any questions the physician has about specific medical issues affecting trial participation. After a sponsor-defined number of days, process 1700 may be initiated again. Finally, if the physician indicated that a colleague may be interested in the study, the process 1700 will utilize this new contact information to begin an outbound communication, looping back to process 1600. The new outbound communication can include colleague referral information. The system may also treat this process differently if the indicated physician has already been sent an initial communication by the system 100 in a previous process (or wave of outbound communications).

### Inbound Physician Communication:

FIG. 18 illustrates an example of inbound physician communication processing. Process 1800 begins with the initial outbound communication at 1805. In this example, the initial outbound communication was a FAX, but as discussed above this initial communication can be multiple different formats. In response to the initial communication at 1805, the physician initiates a return communication at 1815, which is received by the system 100 at 1810. In this example, the return communication is a phone call. In another example, the return communication can be via e-mail, FAX, IVR or over the internet. The system 100 can access the data from the physician call, updates the database and determines the type of follow-up required at 1820.

If there is no follow-up required the process 1800 will exit at 1830. If follow-up is required the process 1800 continues to 1840. At 1840 the process 1800 determines if more information needs to be supplied to the physician. In this example, more information is FAXed or e-mailed to the physician at 1845. The process 1700, physician follow-up, may be initiated again in a sponsor-defined number of days after this additional information is sent.

Next at 1850 the process 1800 determines if the physician requested contact with the study's lead investigator. If contact with the study's lead investigator was requested, the sponsor is notified at 1855. These requests will be sent to the Sponsor's Lead Investigator, so that he/she may contact the physicians directly. This physician-to-physician communication is designed to answer any questions the physician has about specific medical issues affecting trial participation. After a sponsor-defined number of days delay, the process 1700 may be initiated again.

Finally, if the physician indicated that a colleague may be interested in the study, the system will utilize this new contact information to begin an outbound communication, looping back to the process 1600. The new outbound communication can include colleague referral information. The system may also treat this process differently if the indicated physician has already been sent an initial communication by the system 100 in a previous process (or wave of outbound communications).

### Inbound Patient Communications:

FIG. 19 illustrates the inbound patient communications process 1900 that details how the system 100 handles direct patient inquiry. The process 1900 is started at 1910 when a physician determines that he/she has an eligible patient and contacts them regarding the clinical trial. At 1915, the patient determines whether not he/she is interested in learning more about the clinical trial (study). At 1920, the interested patient initiates communication that is received by the system 100 at 1925. In this example the patient communication is via telephone. In another example, the patient communication can be via FAX, e-mail, IVR, or over the internet (e.g. chat, interactive web forms, etc.).

At 1930, the system accesses the information collected from the patient communication at 1925 and updates the database. At 1940, the process 1900 determines if additional information needs to be sent out to the patient. If additional information has been requested, the information is mailed, FAXed, or e-mailed to the patient at 1945. Finally, at 1950 the process 1900 determines whether the patient qualifies for participation in the study. This determination is made based on sponsor-defined inputs for each particular clinical trial and responses from the potential patient. If the patient does qualify, the patient will be referred to the closest study site, see patient referral, an example patient referral process is illustrated in FIG. 20.

### Patient Referral to Study Site:

FIG. 20 illustrates an example of handling patient referrals to clinical trial sites. In an example, the process 2000 has minimal direct interaction with the system 100 such that, after 2010, the referral process 2000 is completed between the clinical trial site and the patient. At 2015, the clinical trial site receives the patient referral and begins processing. An appointment is scheduled at 2020 by engaging some form of communication with the prospective patient at 2025. In this example the communication is done via telephone. In an alternative example the communication can occur via FAX, e-mail or over the internet.

Once an appointment has been scheduled and communicated, the process continues by the prospective patient keeping the scheduled appointment, at 2040. If the appointment is missed, the patient is contacted again and a new appointment is scheduled at 2050. If the patient keeps the appointment, the patient is screened at 2055. If the patient enrolls in the study at 2060 the study is performed at 2070. Performance of the actual study could involve many additional visits and last a period days, weeks, months or years, this is completely dependent on the individual clinical trial.

### Recruitment Analysis:

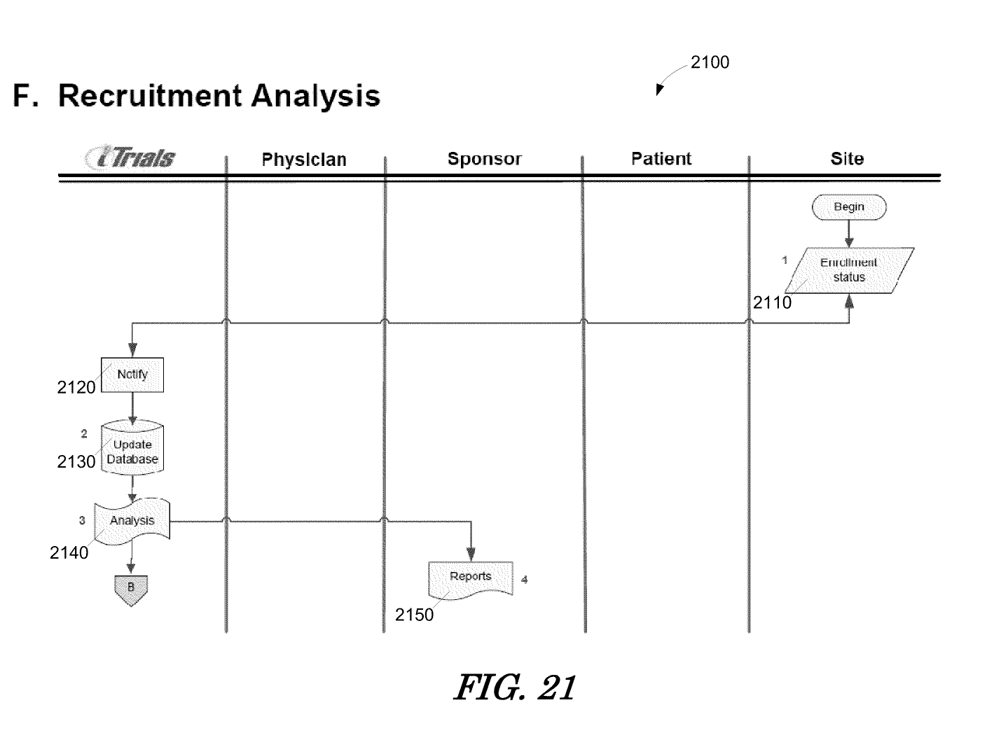

Periodically throughout the clinical trial recruitment process each individual trial site transmits information back to the system 100 for analysis. FIG. 21 illustrates an example of recruitment progress analysis. The process 2100 begins at the trial sites with enrollment status information being sent to back into the system 100 at 2110 and 2120. At 2130 the enrollment status information is added to the recruitment database. In an additional example, the enrollment status information is used to update information within the system's database 120 at 2130. At 2140, the system 100 can analyze the updated recruitment data to determine whether pre-qualified patients expected to response have in fact responded and enrolled or at least been screened. If the system 100 determines that fewer patients than anticipated have responded, the system 100 can initiate process 1700 again to re-connect with targeted physicians. The system 100 can also supply the clinical trial sponsors with detailed reports on recruitment progress, opportunities for process improvements and statistical analysis at 2150.

### 3. Physician Centric Data Model

The Physician Centric Data Model refers to the structuring of data collected from disparate sources. Examples of data collection are includes in the aggregation methods from previous filings, such as U.S. patent application Ser. No. 11/360,800. Data is structured to organize and define characteristics of physicians, physician practices (including their patients), relationships to other physicians, facilities and other information. This data model defines relationships and entities involved in the clinical trial enrollment and referral processes as objects within the data universe (collection of all gather patient, physician, and related information) and maps the corresponding relationships. This allows the various objects and relationships to be understood and defined prior to evaluating these characteristics against a particular clinical trial. Furthermore, this model allows for these objects, characteristics, and relationships, to be continually updated with new data and measured regularly, allowing for each of these objects and relationships to be pre-scored on common criteria which then allows the system to add these general profile rankings and relationships as high scoring characteristics within various offerings.

For example, in the same way that our previous filings and methods are patient centric, in that they collect information over time on specific patients and build a longitudinal health history creating a patient profile, the methods in this new model organize information collected from our data stream into various types of profiles of physicians, physician practices, facilities, and physician referral networks (relationships of physicians to one another).

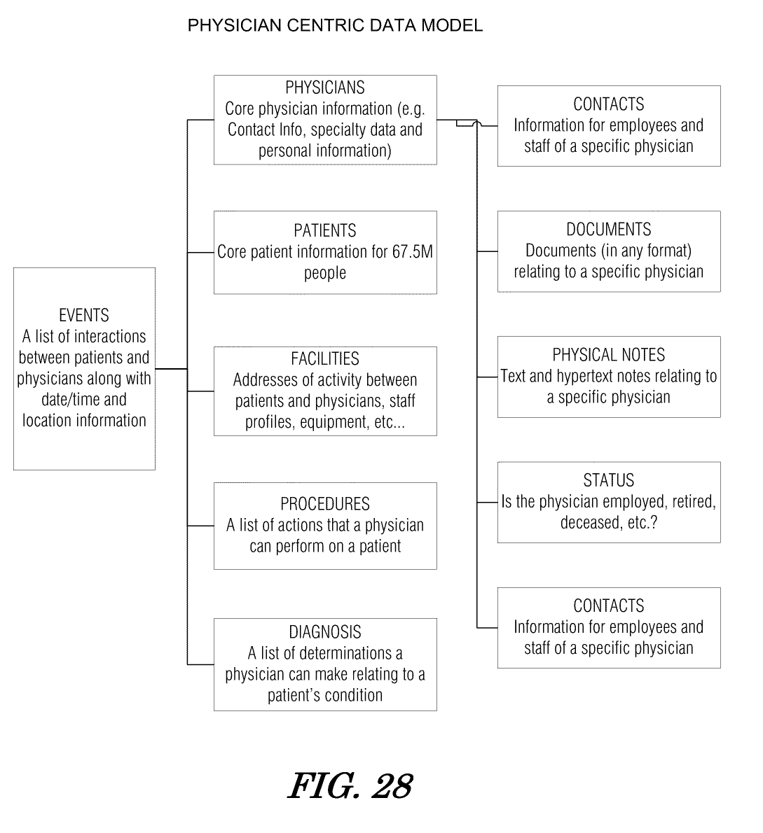

As depicted in FIG. 28, in an example the physician-centric data model centers on physicians with an events table coordinating the interactions between Physicians, Patients, Facilities, Procedures and Diagnosis.

### 4. Protocol Organization

Protocol organization analyzes each clinical trial protocol criteria provided by the sponsor in relationship to the entire patient or physician population. Analyzing each clinical trial criteria individually allows the system 100 to suggest potential modifications to enhance study size, increase patient enrollment, or improve the study's likelihood of success. In an example, the system 100 allows the sponsor to make real-time modifications to the protocol criteria and see how each change might influence the overall patient pool, predicted enrollment rates or eligible physicians.

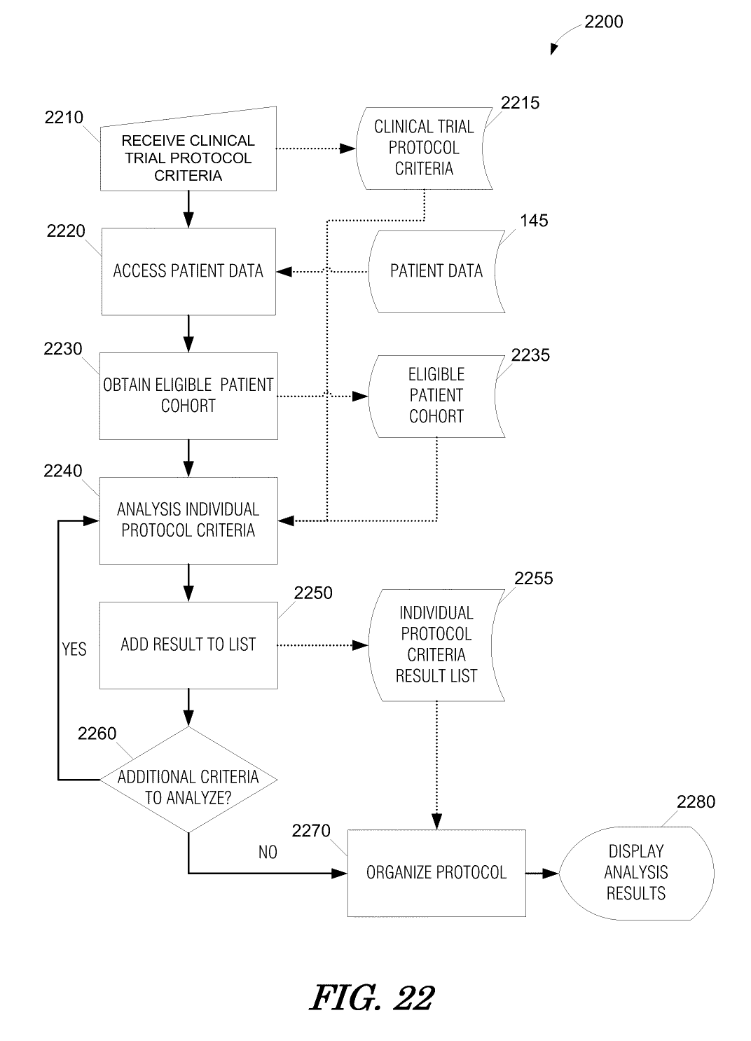

FIG. 22 illustrates an example of a method for clinical trial protocol organization. The protocol organization process 2200 starts by receiving clinical trial protocol criteria at 2210. The clinical trial protocol criteria are stored at 2215 for later use within process 2200. Next patient data is accessed at 2220 from a patient database. In another example, 2220 accesses patient data from the patient database 145. At 2230 the entire patient pool is filtered down to an eligible patient cohort. In an example, the filtering is done utilizing one of the clinical trial protocol criteria; in an example, this is the principal study diagnosis or primary condition. In another example, the filtering is done by comparing the patient's location to the clinical trial site locations and applying a distance threshold. The filtering at 2230 is intended to eliminate any patients that have no chance of being clinical trial candidates (e.g. those that do not meet the more basic requirements). Therefore, any non-negotiable clinical study/trial criteria could be utilized as a filter to obtain the eligible patient cohort.

Once obtained, the eligible patient cohort is saved at 2235 for use in the analysis performed at 2240. The analysis at 2240 is performed on each individual clinical trial protocol criterion with the eligible patient cohort 2235 as input. Any criteria utilized to obtain the eligible patient cohort are not re-analyzed. The analysis results are added to the result list at 2250. The individual protocol criterion result list is saved at 2255 for use in the organization at 2270.

At 2260, the system 100 can determine whether there are additional criteria to analyze. If there are additional protocol criteria to analyze, control loops back to 2240 and the process 2200 proceeds to analyze the next protocol criterion. If there are no more protocol criteria to analyze, the process 2200 proceeds to organize the protocol at 2270. In an example, the protocol organization at 2270 consists of automatically selecting the top ten greatest impacts on patient eligibility. In another example, organization at 2270 focuses on study exclusion criteria first and then considers the study's inclusion criteria. In an example, exclusion criteria are diagnoses that are incompatible with the clinical trial requirements. In an example, inclusion criteria include age, location, and diagnoses required or desired for the clinical trial.

Once organization is completed, the results can be displayed to the user at 2280. In an example, the top five exclusion criteria in terms of patient population impact and the top five inclusion criteria in terms of patient population impact are displayed to the user. In another example, each exclusion and inclusion protocol criteria are displayed in terms of percentage impact on patient population.

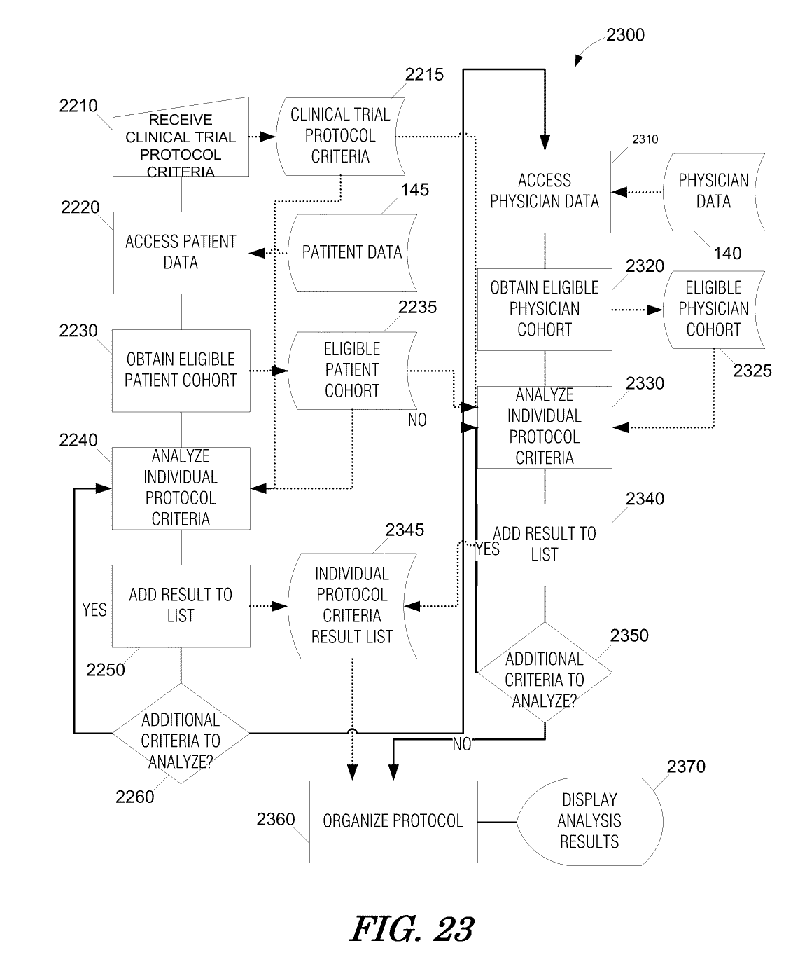

FIG. 23 illustrates another example of a method for clinical trial protocol organization utilizing both eligible patient and eligible physician cohorts. The first half of the process mirrors the process 2200 discussed above. Once all the protocol criteria related to patient inclusion or exclusion have been individually processed against the eligible patient group the process 2300 continues with physicians at 2310. At 2310, physician data is accessed from a database. In an example, the database accessed at 2310 is the physician database 140. Next the process 2300 continues by obtaining an eligible physician cohort at 2320. In an example, the eligible physician cohort is found in a manner similar to the eligible patient cohort. In another example, the eligible physician cohort is obtained by filtering all physicians in the database 140 against an FDA blacklist. In yet another example, the eligible physician cohort is obtained by filtering the physician database 140 by a set of specialties approved by the study sponsor.

At 2330 the eligible physician cohort is analyzed against the physician relevant individual protocol criteria. The result of the analysis is the added to the result list 2345 at 2340. Then the process 2300 checks to see if additional protocol criterion are yet to be analyzed at 2350. If there are additional protocol criteria to analyze the process 2300 loops back to 2310 and continues until all criteria have been analyzed.

Once all patient and physician related protocol criteria have been analyzed the system 100 can perform organization at 2360 similar to the process 2200 discussed above. After organization, the system 100 can display the results at 2370.

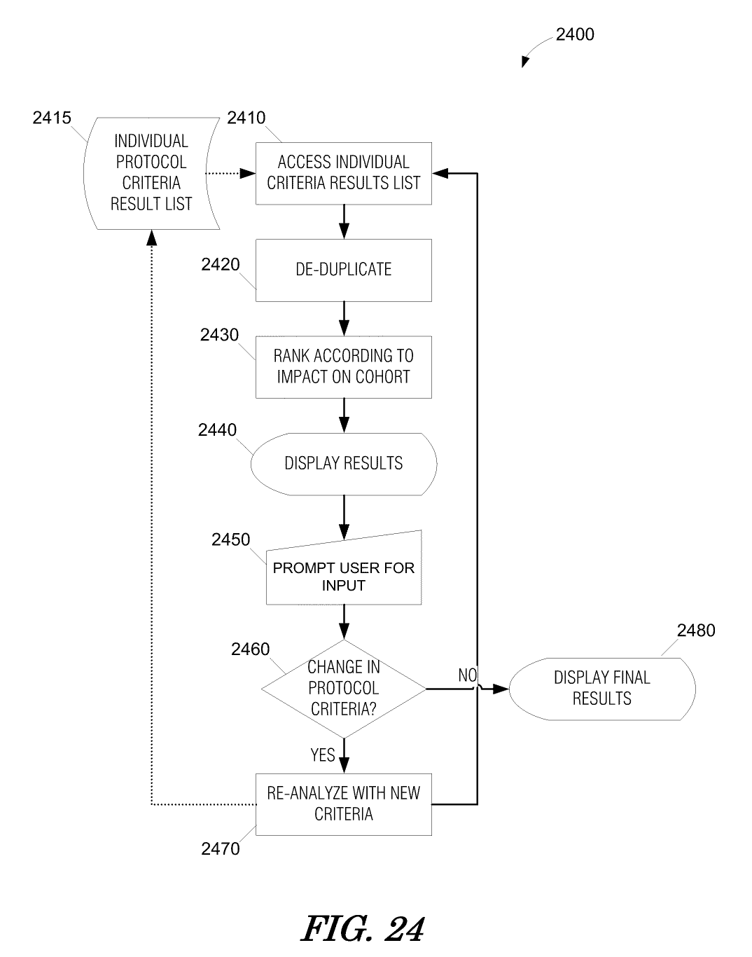

FIG. 24 illustrates an example of a method for interactive clinical trial protocol organization, this process 2400 can be utilized in place of process 2360 or 2270 discussed previously. This example demonstrates an interactive organization process 2400 that allows the user to select different combinations of protocol criteria and visualize impacts on patient or physician eligibility.

The interactive organization process 2400 begins at 2410 by accessing the individual criteria results list represented by 2415. Next the process 2400 de-duplicates the results at 2420. De-duplication 2420 ensures that patients are not counted more than once when determining impact on the cohort. After de-duplication, the process 2400 ranks the protocol criteria according to magnitude of impact on the relevant cohort at 2430. At 2440 the rank ordered results are displayed. In an example the display is simply an ordered list of protocol criteria. In another example, the top five largest impact protocol criteria displayed in graphical format (e.g. a bar graph).

After providing the user with a display of results, the process 2400 allows the user to select a different set of protocol criteria at 2450. The process 2400 then determines whether the user changed the set of protocol criteria at 2460. If the protocol criteria set was edited, the process 2400 loops back to 2410 and starts the process over. This allows the user to work through various scenarios, determining the impact of patient and physician eligibility based on various combinations of clinical trial protocol criteria. The process 2400 ends when the user makes no further changes to the criteria. The final results are then displayed at 2480.

### 5. Protocol Translation:

The clinical trial protocol inclusion and exclusion criteria received from study sponsors do not always conform to how the relevant physician, patient, or diagnosis data is stored in the available databases. The following process 2500 describes an example method of translating clinical trial protocol criteria into searchable data points that allow assessment of physician and patient eligibility for the clinical trial.

International statistical classification of diseases and related health problems (ICD9 codes) provide an internationally recognized method to classify diseases and a wide variety of signs, symptoms, abnormal findings, complaints, social circumstances and external causes of injury or disease. Every health condition is assigned a code that uniquely identifies it. The ICD is published by the World Health Organization and is used world-wide for morbidity and mortality statistics, billing systems and automated decision support processes.

Another common method of coding health conditions is the Current Procedural Terminology (CPT) code set maintained by the American Medical Association. The CPT attempts to accurately describe medical, surgical, and diagnosis services and is designed to communicate uniform information about medical services and procedures. CPT codes are utilized by physicians, patients, accreditation organizations, insurance companies, as well other financial and analytical functions within the medical community.

If medication is involved in the clinical trial protocol the criteria may include National Drug Codes (NDC). NDC is a unique identifier assigned to each medication listed under Section 510 of the U.S. Federal Food, Drug, and Cosmetic Act. The identifier can be interpreted to determine the labeler or vendor, product, and trade package size.

Both ICD and CPT codes provide a starting point for converting clinical trial criteria into searchable data points. In an example, much of the relevant patient and physician data will be stored as ICD or CPT codes. However, in another example, the ICD and CPT codes may be inadequate for describing the clinical trial protocol criteria with sufficient specificity. In a specific example, the cancer coding available through ICD codes simply lists the location of the tumor. The ICD code (or codes) does not provide details like whether the tumor is primary, second primary, or a metastases of another cancer. This additional detail, not available with ICD or CPT codes can be critical to evaluating eligibility. In an example, there may also be additional elements that do not necessarily translate to ICD or CPT codes, such as required office equipment, physician staff profiles, or patient density requirements to name a few. Additionally, clinical trial protocol criteria do not always follow ICD or CPT code constraints. The following process 2500 depicts an example method of creating searchable data points from a set of clinical trial protocol criteria.

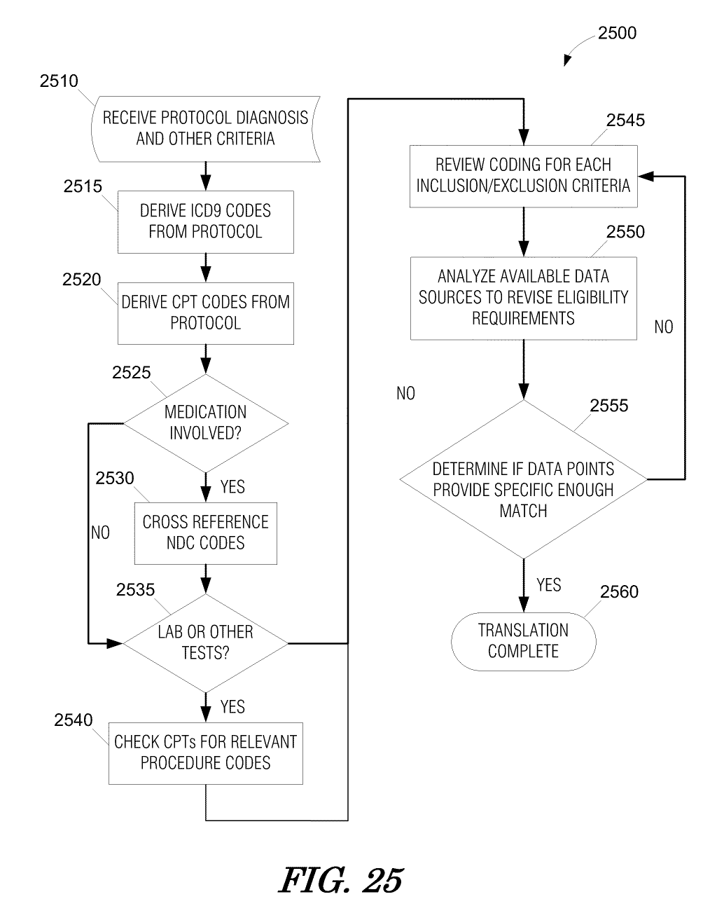

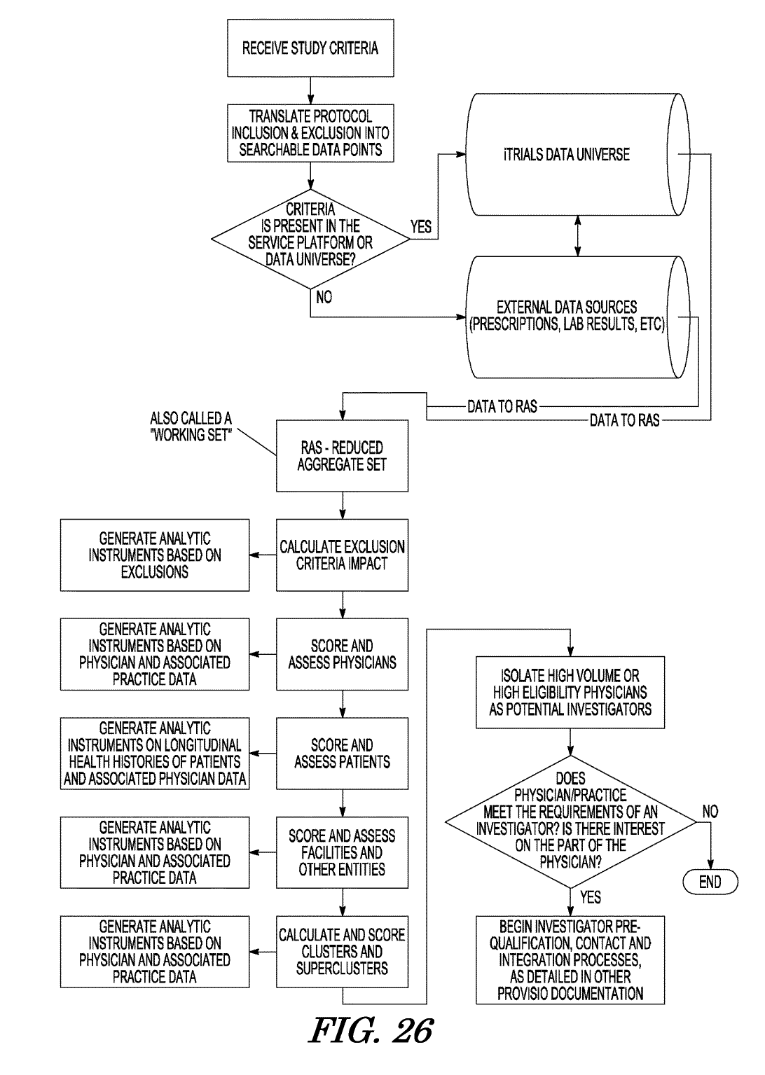

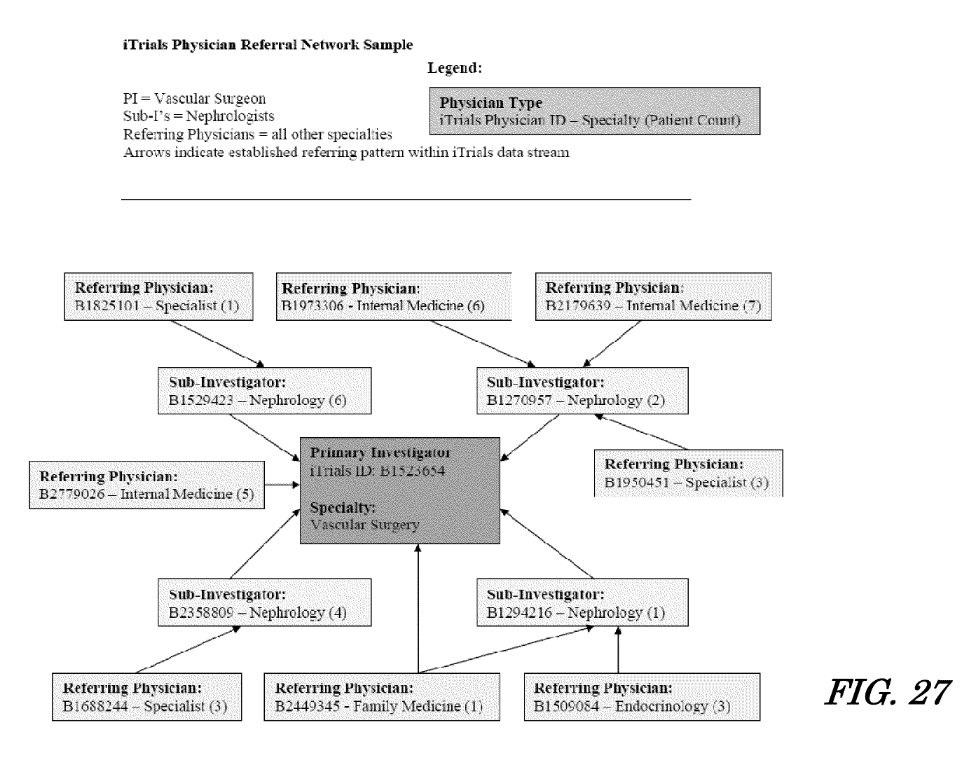

FIG. 25 illustrates an example method of translating clinical trial protocol criteria into searchable data points for use within a system for developing clinical trials. The method 2500 begins by receiving the protocol criteria at 2510. At 2515 ICD codes are derived from the received protocol criteria. In an example, the derivation 2515 is done by matching text strings between ICD codes and the protocol diagnosis. In another example, the derivation 2515 is done by simply matching ICD codes provided in the protocol criteria against a list of valid codes. In yet another example, the derivation 2515 uses a combination of text matching and manual selection to derive the ICD codes. In still another example, derivation 2515 consists of a combination of ICD code verification, text string matching and manual selection. Once derived, the ICD codes are added to the group of searchable data points used to determine patient or physician eligibility.

Once all ICD codes are derived from the protocol criteria, CPT codes are derived at 2520 utilizing a similar process. In an example, the derivation 2520 consists of a simple verification process, verifying that CPT codes provided with the protocol criteria are valid. In another example, derivation 2520 includes text string matching against all available CPT codes. In yet another example, the derivation 2520 includes text string matching and manual selection of the CPT codes determined to be relevant to the protocol criteria. Once derived, the CPT codes are added to the group of searchable data points.

Next the process 2500 determines whether any medication is involved in the study at 2525. If medication is involved, NDC codes are cross referenced and included in the group of searchable data points. Otherwise, the process 2500 moves on to determine whether lab or other tests will be involved in the study at 2535. If no lab or other tests, then the process 2500 jumps to a review of the coding at 2545. If there are lab or other tests involved, then the CPTs are checked for relevant procedure codes. Any additional relevant CPTs, not found at 2520, are then added to the group of searchable data points.

Each inclusion and exclusion criteria received for the clinical trial protocol is reviewed at 2545. In an example, this coding review of each inclusion and exclusion criteria is done manually to ensure all relevant data points are included in the search group 2570. In addition to the coding review at 2545, each criteria is analyzed 2550 in relationship to the available data source to determine if eligibility requirements should be revised, additional codes included, or additional data points not represented by any specific code included in the searchable data points group. In an example, a protocol criterion of informed consent requires that the patient be of sound mind and body to render informed consent and sign a legally-binding document. This type of criteria may add exclusion criteria (or codes) such as a minimum age, mental disability codes or anti-psychotic drug prescriptions to the searchable data points group. Processes 2545 and 2550 are where criteria that require a medical judgment call can be factored into the group of searchable data points.

At 2555 a final determination is made regarding the match between the searchable data points and the clinical trial protocol criteria. If the match is determined to be sufficient to enable determination of eligible patients and physicians the translation is considered complete 2560. If the match is determined to be insufficient, the process 2500 loops back to 2545 for further review and analysis.

Please note that the following terms used through this application are intended to have the following definitions. Physician is used within this application to mean any healthcare worker including any medical practitioner, medical doctor, nurse, physician's assistants, or nurse practitioners unless specifically limited by usage or definition associated with the specific reference. Data universe is used to generically refer to a group of data collected for use within the described system. In an example, data universe is the physician, patient and related clinical trial study information data warehouse that includes one or more actual databases.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

The claimed invention is:

1. A method for selecting a clinical trial site, the method comprising:
accessing a patient population database to obtain an eligible group of clinical trial patients;
identifying a group of potential clinical trial sites using the group of clinical trial patients;
accessing a physician database, the physician database including a physician record for each of a plurality of physicians, each physician record including a plurality of physician characteristics;
identifying a group of potential physicians using the group of potential clinical trial sites; and
selecting the clinical trial site using:
a density of eligible patients calculated from the group of clinical trial patients, and
at least one of the plurality of physician characteristics scored by at least one user-defined criteria of the clinical study.

2. The method of claim 1, wherein identifying the group of potential clinical trial sites includes identifying geographic clusters within the group of clinical trial patients.

3. The method of claim 2, wherein identifying the group of potential clinical trial sites includes eliminating geographic clusters of eligible patients within a user-specified distance from an active clinical trial site.

4. The method of claim 1, wherein selecting the clinical trial site includes:
determining, within the group of potential physicians, a number of physicians with a preference for using a user-defined procedure; and
determining whether the number of physicians with a preference for using a user-defined procedure transgresses a user-defined threshold.

5. The method of claim 1, wherein selecting the clinical trial site includes determining whether the group of potential physicians includes a user-defined minimum number of physicians with a user-defined qualification.

6. The method of claim 1, wherein selecting the clinical trial site includes determining whether the group of potential physicians includes a user-defined minimum number of physicians with at least one of:
a user-defined referral pattern,
a user-defined office staff profile; and
a user-defined equipment profile.

7. A method for selecting an eligible investigator for a clinical trial, the method comprising:
accessing a physician database, the physician database including a physician record for each of a plurality of physicians, each physician record including a plurality of physician characteristics;
identifying, using one or more processors, a group of potential investigators, the identifying including:
using a user-specified criterion of the clinical trial associated with at least one of the plurality of physician characteristics to select a physician for the group of potential investigators; and
determining, for each physician considered for the group of potential investigators, a number of eligible patients for the clinical trial; and
selecting physicians, for the group of potential investigators, were the physician's number of eligible patients exceeds a user-defined threshold;
identifying an eligible investigator from the group of potential investigators; and
presenting information regarding the eligible investigator to a user.

8. The method of claim 7, further comprising:
accessing a patient population database to obtain a group of patients eligible for the clinical trial; and
identifying a clinical trial site using the group of clinical trial patients.

9. The method of claim 8, wherein identifying the group of potential investigators includes determining whether each physician considered for the group of potential investigators is located within a user-defined distance from the clinical trial site.

10. The method of claim 8, wherein identifying the group of potential investigators includes determining whether each physician considered for the group of potential investigators is located within a user-defined distance of a user-defined minimum number of patients eligible for the clinical trial.

11. The method of claim 7, wherein the plurality of physician characteristics includes a physician qualification; and
wherein identifying the group of potential investigators includes determining that each physician considered for the group of potential investigators maintains qualifications meeting at least one user-defined qualification for the clinical trial.

12. The method of claim 7, wherein the plurality of physician characteristics includes a physician's preference for a particular procedure; and
wherein identifying the group of potential investigators includes selecting the physicians whose preference for a particular procedure meets at least one user-defined preference for a particular procedure for the clinical trial.

13. The method of claim 7, wherein the plurality of physician characteristics includes a equipment profile; and
wherein identifying the group of potential investigators includes selecting the physicians whose equipment profile meets at least one user-defined equipment profile for the clinical trial.

14. The method of claim 7, wherein the plurality of physician characteristics includes a office staff profile; and
wherein identifying the group of potential investigators includes selecting the physicians whose office staff profile meets at least one user-defined office staff profile for the clinical trial.

15. The method of claim 7, wherein the presenting includes displaying information regarding the group of potential investigators.

16. The method of claim 7, further comprising:
scoring the list of potential investigators by comparing at least one physician characteristic with at least one user-specified criteria of the clinical trial to provide a scored list of potential investigators; and
wherein the identifying an eligible investigator includes using the scored list of potential investigators.

17. The method of claim 16, wherein presenting includes presenting information regarding the scored list of potential investigators.

18. The method of claim 16, wherein scoring includes using a plurality of physician characteristics and a plurality of user-specified criteria of the clinical trial.

19. The method of claim 18, wherein scoring includes weighing at least one of the user-specified criteria of the clinical trial.

20. A system comprising:
a physician database, the physician database including a physician record for each of a plurality of physicians, each physician record including a plurality of physician characteristics;
a patient database, including a patient record for each of a plurality of patients, each patient record including an association with a physician record in the physician database;
a computer including a memory and a processor, the memory including instructions which, when performed by the processor, cause the computer to:
identify a group of potential investigators, from the plurality of physicians in the physician database, the identifying including:
receiving a user-specified criterion of the clinical trial associated with at least one of the plurality of physician characteristics to select a physician for the group of potential investigators; and
determining, for each physician considered for the group of potential investigators, a number of eligible patients for the clinical trial; and
selecting physicians, for the group of potential investigators, were the physician's number of eligible patients exceeds a user-defined threshold;
identifying an eligible investigator from the group of potential investigators; and
presenting, on a user-interface, information regarding the eligible investigator.

21. The system of claim 20, wherein the memory includes instructions which, when performed by the processor, cause the computer to:
access the patient database to determine a group of patients eligible for the clinical trail; and
identify a clinical trial site using the group of clinical trial patients.

22. The system of claim 21, wherein the identifying the group of potential investigators includes determining whether each physician considered for the group of potential investigators is located within a user-defined distance from the clinical trial site.

23. The system of claim 21, wherein identifying the group of potential investigators includes determining whether each physician considered for the group of potential investigators is located within a user-defined distance of a user-defined minimum number of patients eligible for the clinical trial.

24. The system of claim 21, wherein the memory includes instructions which, when performed by the processor, cause the computer to:
score the list of potential investigators by comparing at least one physician characteristic with at least one user-specified criteria of the clinical trial to provide a scored list of potential investigators; and
wherein the identifying an eligible investigator includes using the scored list of potential investigators.

25. The system of claim 24, wherein scoring includes using a plurality of physician characteristics and a plurality of user-specified criteria of the clinical trial.

26. The system of claim 25, wherein scoring includes weighing at least one of the user-specified criteria of the clinical trial.

27. A method for selecting a location of a clinical trial site, comprising:
accessing a patient population database to obtain a group of patients eligible for the clinical trial;
accessing a physician database that includes a plurality of physician characteristics associated with physicians in the database;
identifying a group of potential investigators using at least one of the plurality of physician characteristics;
scoring the group of potential investigators using at least one user-defined criteria for the clinical trial to provide a scored group of potential investigators;
determining, using a processor, the location of the clinical trial site using at least one of the scored group of potential investigators and the group of patients eligible for the clinical trial.

28. The method of claim 27, wherein determining the location of the clinical trial site includes identifying one or more logical clusters within the group of patients eligible for the clinical trial.
